(19) United States
(12) Patent Application Publication
(10) Pub. No.: US 2009/0267270 A1
(43) Pub. Date: Oct. 29, 2009

(54) PROCESS FOR PRODUCING FILM WITH CONCAVO-CONVEX PATTERN

(75) Inventors: Takashi Murakami, Tokyo (JP); Toshiaki Shibue, Tokyo (JP); Takeshi Tanaka, Hyogo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA OPTO, INC., Tokyo (JP)

(21) Appl. No.: 12/066,614

(22) PCT Filed: Aug. 18, 2006
(86) PCT No.: PCT/JP2006/316216

§ 371 Date: Mar. 12, 2008

(30) Foreign Application Priority Data
Sep. 20, 2005 (JP) 2005-271737

(51) Int. Cl. B29C 59/04; B29C 59/16

(52) U.S. Cl. 264/447

(57) ABSTRACT

The present invention provides a process for producing a concavo-convex pattern film which excels in its peelability from an embossing roll and in coatability of an anti-reflection layer, etc. There is provided a process of producing a concavo-convex pattern film by forming a concavo-convex pattern on the surface of a transparent resin film employing an embossing roll having on the surface a convex-concavo pattern, characterized in that the embossing roll is made of glass and a photocatalyst layer is provided on the surface of the embossing roll, characterized in that the process comprises the steps of introducing a UV curable resin composition between the embossing roll and a transparent resin film provided around the embossing roll to form a UV curable resin layer, exposing the UV curable resin layer to UV rays to form a UV cured resin layer having on the surface a concavo-convex pattern, the UV rays being emitted from the interior of the embossing roll, and peeling the UV cured resin layer together with the transparent resin film from the embossing roll.

### FIELD OF THE INVENTION

The present invention relates to a process for producing a film with a concavo-convex pattern employing an embossing roll.

### PRIOR ART

A liquid crystal display for a personal computer, a word processor or a liquid crystal television has a surface light source on the back side from which light (also referred to as backlight) is irradiated, since the liquid crystal itself cannot emit light. As a method of uniformly irradiating the whole of the display panel employing a backlight, there is a jet-light method in which a line light from a line light source is caused to be incident onto the side face of a light guide with a light scattering pattern to emit a flat light.

Such a surface light source comprises a light guide plate having a reflection plate on the rear surface, in which light caused to be incident onto the side face of the light guide plate is irradiated from the light-emerging face; optical films having optical functions such as a light diffusing film, a polarized light separating film, a lens film and a protective light diffusing film, which are provided in order to scatter and diffuse light and to give uniform luminance at the irradiated area; and an anti-glaring film on the front surface for preventing light reflection. The optical films are required to have good light scattering property, light diffusing property, light transmission property and color rendering property, and to heal the light scattering pattern due to the light guide plate. Further, when the optical films are used to be in contact with another polarizing light separation film or lens film, it is required that no interference fringes are produced.

In order to obtain a sufficient luminance required in the color liquid crystal display, a higher light transmission property and light emerging toward the front direction are required. In order to meet the requirements, there is proposed a film comprising a transparent substrate film and provided thereon, an optical function layer having a concavo-convex pattern on the surface as one kind of optical films such as a light scattering film, a protective light scattering film, and an antiglaring film.

As a method for producing a concavo-convex pattern on the film, there is a method which comprises the steps of rotating an embossing roll having a concavo-convex pattern whose concavo portions are filled with ionization radiation curable resin, transporting a transparent substrate in the rotational direction of the roll in synchronism with the rotation, the substrate being in contact with the roll, exposing the ionization radiation curable resin to ionization radiation to form an ionization radiation cured resin, allowing the ionization radiation cured resin to adhere onto the transparent substrate during curing, and then peeling the substrate from the embossing roll. It is important for the embossing roll to have a concavo-convex pattern which is uniform within the necessary area and provides the intended optical function.

Generally, an embossing roll has a fine concavo-convex pattern on the surface of a roll core (hereinafter simply referred to as a roll), or a roll plate or a roll film. As a method for forming a concavo-convex pattern known are engraving, electroforming, sand blasting, discharge processing and etching. However, these techniques have problem in that it is difficult to form a concavo-convex pattern which is uniform and without unevenness over the whole of required region. A blasting method employing a resist is known (see for example Patent Document 1). As a method for preparing a light scattering member by transferring the concavo-convex pattern of a roll (corresponding to the embossing roll above), there is known a method in which the concavo-convex pattern is formed by sand blasting, followed by etching treatment and/or lamination of a film (see for example Patent Document 2). A method is known which forms a metal plated layer on the surface of an embossing roll, and subjects the metal plated layer to sand blasting with ceramics beads to form a concavo-convex pattern (see for example Patent Document 3). A method for preparing an antireflection film is proposed which coats an ionization radiation curable resin on the surface of a molding roll having a regular concavo-convex pattern on the surface, whereby the concavo-convex pattern is filled with ionization radiation curable resin, rotating the molding roll, bringing a continuously running transparent substrate film into contact with the rotating roll, exposing the ionization radiation curable resin to ionization radiation through the transparent substrate film to form an ionization radiation cured resin, allowing the ionization radiation cured resin to adhere onto the transparent substrate film during curing, and then peeling the substrate transparent substrate film with the ionization radiation cured resin from the embossing roll (see for example Patent Document 4). A method for preparing a film with a cured concavo-convex pattern is disclosed which provides a film in sheet form coated with a UV curable resin layer on the concavo-convex pattern layer of an embossing roll, and exposing the UV curable resin layer to UV ray through the film in sheet form (see for example Patent Document 5).

However, these techniques have problem in peeling a film having a concavo-convex pattern formed on the surface from an embossing roll, which produces problems in properties and productivity of the concavo-convex pattern film.

A method for preparing a polymer film sheet having a concavo-convex pattern is disclosed which cures a UV curable resin composition via UV ray from the inside of a hollow roll having a concavo-convex pattern composed of UV ray transmitting material such as quartz glass to form a UV cured resin layer having a concavo-convex pattern, a UV light source for emitting the UV ray such as a high pressure mercury lamp being installed in the inside of the hollow roll, and transfers the UV cured resin layer having concavo-convex pattern to a polymer film sheet (see for example Patent Document 6). However, this method also has problem in peeling the film sheet from the roll. When an antireflection layer is further provided on the formed concavo-convex pattern, coating fault such as transverse-streaking or streaking is likely to occur, and the improvements have been sought.

### Patent Document No. 1: 7-144364

### Patent Document No. 2: 2000-284106

### Patent Document No. 3: 2004-901.87

### Patent Document No. 4: 2002-333508

### Patent Document No. 5: 2005-138296

### Patent Document No. 6: 2001-347220

### DISCLOSURE OF THE INVENTION

### Problems to be Solved by the Invention

An object of the invention is to provide a process for producing a concavo-convex pattern film which excels in its peelability from an embossing roll and in coatability of an anti-reflection layer.

### Means for Solving the Problems

The above object has been attained by any one of the following constitutions.

1. A process of producing a concavo-convex pattern film by forming a concavo-convex pattern on the surface of a transparent resin film employing an embossing roll having on the surface a convex-concavo pattern, characterized in that the embossing roll is made of glass and a photocatalyst layer is provided on the surface of the embossing roll, and in that the process comprises the steps of introducing a UV curable resin composition between the embossing roll and a transparent resin film provided around the embossing roll to form a UV curable resin layer, exposing the UV curable resin layer to UV rays to form a UV cured resin layer having on the surface a concavo-convex pattern, the UV rays being emitted from the interior of the embossing roll, and peeling the UV cured resin layer together with the transparent resin film from the embossing roll.

2. The process of producing a concavo-convex pattern film of item 1 above, characterized in that the glass is quartz glass.

3. The process of producing a concavo-convex pattern film of item 1 or 2 above, characterized in that the embossing roll is prepared by sand blasting treatment.

4. The process of producing a concavo-convex pattern film of item 1 or 2 above, characterized in that the embossing roll having on the surface a convex-concavo pattern is prepared by hydrogen fluoride treatment.

5. The process of producing a concavo-convex pattern film of any one of items 1 through 4 above, characterized in that the transparent resin film absorbs ultraviolet rays.

6. The process of producing a concavo-convex pattern film of any one of items 1 through 5 above, characterized in that the peeling is carried out through a peeling roll.

7. The process of producing a concave-convex pattern film of any one of items 1 through 6 above, characterized in that the concavo-convex pattern film is an antiglaring film.

### EFFECTS OF THE INVENTION

The present invention can provide a process for producing a concavo-convex pattern film which is excellent in its peelability from an embossing roll, whereby no residues remain on the embossing roll, resulting in high productivity and high film properties, and provide a process for producing a concavo-convex pattern film in which particularly when an antireflection layer is coated on the film, coating fault such as transverse streak or streak is difficult to occur.

### BRIEF EXPLANATION OF THE DRAWINGS

FIG. 1 is an illustration explaining sand blasting treatment in the invention.

FIG. 2 is an illustration showing the process of the invention for producing a concavo-convex pattern film.

FIG. 3 is an illustration showing a section of an antiglaring antireflection film in the invention.

### EXPLANATION OF NUMERICAL NUMBERS

1. Roll
27. Roll axis
31. Conveyer
33. Pedestal
35. Bearings
37. Jetting nozzles
1′. Embossing roll
2. Transparent resin film
3. Coating apparatus
4. UV ray curable resin composition
5. Transparent resin film supply roll
6. Guide rolls
7. Drying zone
8. Backup roll
9. Concavo-convex pattern film take-up roll
10. UV ray irradiation apparatus
100. Transparent resin film
101. Low refractive index layer
102. High refractive index layer
103. Medium refractive index layer
104. UV ray cured resin layer
105. Antireflection layer
106. Back coat layer

### PREFERRED EMBODIMENT OF THE INVENTION

Next, the preferred embodiment of the invention will be explained in detail.

The present invention is a process of producing a concavo-convex pattern film, employing an embossing roll having on the surface a convex-concavo pattern, characterized in that the embossing roll is made of glass and a photocatalyst layer is provided on the surface of the embossing roll, and in that the process comprises the steps of providing a transparent resin film coated with a UV curable resin composition layer on the embossing roll so that the UV curable resin composition layer faces the embossing roll, exposing the UV curable resin layer to UV rays, which are emitted from the interior of the embossing roll, and peeling the transparent resin film from the embossing roll.

In the invention, a method of preparing a glass embossing roll having a concavo-convex pattern on the surface is not specifically limited, but the glass embossing roll can be prepared by a method in which a glass roll is subjected to etching treatment employing hydrogen fluoride or sand blasting treatment. The glass roll in the invention is preferably made of quartz glass. The quartz glass is glass composed of silicon dioxide (SiO₂) alone, which is also called fused quartz, silica glass or fused silica. The quartz glass has a density of 2.2 g·cm⁻³, a softening point of 1650° C., a specific heat of 0.201 cal·g⁻¹, and a coefficient of thermal expansion of 5.5 to 5.8×10⁻⁷/° C., which is extremely low and therefore, excels in thermal shock resistance. The quartz glass has a refractive index ND of 1.4585 and has high UV transmission. The quartz roll can be prepared melting quartz, quartz crystal, quartz rock or silica sand, and cooling and processing the melted material.

The quartz has high UV transmission, and therefore, it makes it possible to prepare an embossing roll structured so as to emit UV light from the interior of the roll.

### (Sand Blasting Treatment)

The sand blasting treatment is preferably carried out which blasts particles having an average particle size of not more than 10 μm at a blasting pressure (gauge pressure) of not less than 200 kPa. When the average particle size of the blasting particles is over 10 μm, the blasting pressure (gauge pressure) is preferably not less than 200 kPa, providing initial minute pores having an optimal depth. The particle size distribution of the blast particles is preferably sharp. The blast particles having a sharp particle size distribution improve uniformity of an antiglaring optical film obtained. Examples of the blasting particles include Sumikorandom AA-5 (average particle size of 5 μm) and Sumikorandom AA-18 (average particle size of 18 μm) each produced by Sumitomo Kagaku Kogyo Co., Ltd.

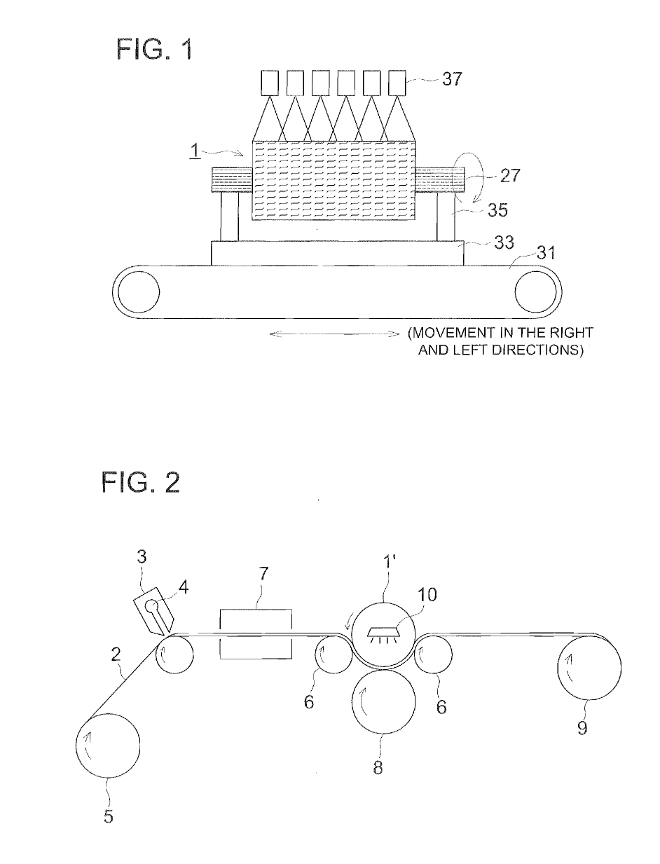

Employing FIG. 1, the sand blasting treatment in the invention will be explained.

As shown in FIG. 1, roll 1 is rotatably fixed by roll axis 27 provided on the bearings 35 positioned left and right on the pedestal 33 on the conveyer 31. The roll 1 has a metal plated layer whose surface is mirror polished. The roll 1 is rotated through the embossing roll axis 27 by a driving source not illustrated and is moved right and left by the conveyer 31. During the rotation and movement, blast particles are blasted from the jetting nozzles 37 through a compressed air onto the entire surface of the roll 1. The blasting forms a fine concavo-convex pattern on the entire surface of the roll 1 to obtain an embossing roll. The rate of the rotation or movement, the blast particle amount to be blasted or the blasting time can be suitably selected so as to obtain an intended concavo-convex pattern. The roll may be embossed over the entire surface from one end to the other end thereof, but it is preferred that the roll is not embossed at the portions 1 to 20 cm distant from the both ends of the roll, which are used for supporting the roll.

### (Etching Treatment)

In the etching treatment employing hydrogen fluoride, a solution containing hydrogen fluoride used is a hydrofluoric acid solution having a hydrogen fluoride concentration of preferably from 1 to 10% by weight, and more preferably from 5 to 10% by weight. A hydrogen fluoride concentration exceeding 10% by weight lowers in-plain uniformity of a roughened surface produced by etching, which is undesirable. A hydrogen fluoride concentration less than 1% by weight extremely lowers the etching speed, which is not practicable.

The etching temperature is preferably from 20 to 50° C., and more preferably from 30 to 40° C. The etching temperature less than 20° C. cannot provide practical etching speed, which is undesirable. The etching temperature exceeding 40° C. lowers in-plain uniformity of a roughened surface produced by etching, which is undesirable.

In a method of forming a concavo-convex pattern on a glass surface, the concavo-convex pattern may be formed on a glass surface by subjecting the glass surface to sand blasting treatment to form a finely roughened surface, and then subjecting the roughened surface to etching treatment employing an aqueous hydrogen fluoride solution.

### (Embossing Treatment)

It is preferred that the concavo-convex pattern on the surface of the quartz embossing roll is formed randomly. The arithmetic average surface roughness (Ra) of the concavo-convex pattern is preferably from 0.02 to 2 μm and the average periodic distance (Sm) thereof is preferably not more than 200 μm, and more preferably not more than 100 μm. The arithmetic average surface roughness of the concavo-convex pattern is more preferably from 0.05 to 1.5 μm, still more preferably from 0.07 to 1.2 μm, and most preferably from 0.1 to 1.0 μm. The arithmetic average surface roughness less than 0.02 μm cannot provide sufficient antiglaring function, while the arithmetic average surface roughness exceeding 2 μm provides lowered resolution and less-visible image due to reflected light.

The Sm exceeding 200 μm lowers resolution, and provides harshness on the film surface, resulting in lowering of quality. The average periodic distance of the concavo-convex pattern is preferably from 5 to 100 μm, and more preferably from 10 to 50 μm.

Ra and Sm are those defined in JIS B0601.

The arithmetic average surface roughness and the average periodic distance of the concavo-convex pattern can be measured through a surface roughness meter available on the market. In the invention, they can be measured through a compact surface roughness meter (TYPE SJ-401 produced by Mitsutoyo Co., Ltd.).

In the embossing process in the invention, the line pressure between an embossing roll and a backup roll is preferably from 100 to 1200 N/cm, and more preferably from 500 to 4000 N/cm.

The embossing roll is equipped with a tem adjusting system, and the temperature of the embossing roll can be appropriately controlled. For example, the temperature of the embossing roll can be controlled by supplying air for adjusting temperature to the interior of the roll, or by pressing a temperature-controlled roll onto the outer surface or inner surface of the roll. By this temperature control, a film is heated to preferably 20 to 150° C., and more preferably from 40 to 140° C.

The temperature distribution in the transverse direction of the roll is in the range of preferably ±10° C., more preferably ±5° C., and most preferably ±10° C. The concavo-convex pattern forming speed is preferably from 0.3 to 50 m/minute, and more preferably from 1 to 30 m/minute.

A fluorine or silicon based water or oil repelling layer is preferably provided on the embossing roll surface. It is preferred that the water or oil repelling layer is provided on the embossing roll surface by coating of a coating solution containing a fluoroalkylsilane compound, a fluoroalkyl ether silane compound or silicon oil or by CVD treatment. The resulting layer has a contact angle of preferably not less than 90 degrees. As compounds used, there are known compounds which are added to a low refractive index layer or an anti-stain layer of an antireflection film.

### (UV Curable Resin Composition)

The UV curable resin composition in the invention is one in which a prepolymer, oligomer and/or monomer having in the molecule a polymerizable unsaturated bond or an epoxy group are appropriately mixed.

Examples of the prepolymer or oligomer include unsaturated esters such as condensation products of unsaturated dicarboxylic acids with polyhydric alcohols; methacrylates such as polyester methacrylates, polyether methacrylates, polyol methacrylates or melamine methacrylates; acrylates such as polyester acrylates, epoxy acrylates, urethane acrylates, polyether acrylates, polyol acrylates or melamine acrylates; and cationically polymerizable epoxy compounds.

Examples of the monomer include styrene monomers such as styrene or α-methylstyrene; acrylates such as methyl acrylate, 2-ethylhexyl acrylate, methoxyethyl acrylate, butoxyethyl acrylate, butyl acrylate, methoxybutyl acrylate or phenyl acrylate; methacrylates such as methyl methacrylate, ethyl methacrylate, propyl methacrylate, methoxyethyl methacrylate, ethoxymethyl methacrylate, phenyl methacrylate or lauryl methacrylate; aminoalcohol esters having an unsaturated group such as 2-(N,N-diethylamino)ethyl acrylate, 2-(N,N-dimethylamino) ethyl acrylate, 2-(N,N-dibenzylamino)methyl acrylate or 2-(N,N-diethylamino)propyl acrylate; unsaturated carboxylic acid amides such as acrylamide or methacrylamide; compounds such as ethylene glycol diacrylate, propylene glycol diacrylate, neopentyl glycol diacrylate, 1,6-hexanediol diacrylate, or triethylene glycol diacrylate; polyfunctional compounds such as dipropylene glycol diacrylate, ethylene glycol diacrylate, propylene glycol dimethacrylate, diethylene glycol dimethacrylate; and polythiol compounds having in the molecule two or more of a thiol group such as trimethylolpropane trithioglycolate, trimethylolpropane trithiopropylate or pentaerythritol tetrathioglycolate.

In order to harden the UV curable resin composition with UV rays, UV rays emitted from a light source such as a super high pressure mercury lamp, a high pressure mercury lamp, a low pressure mercury lamp, a carbon arc lamp, a xenon arc lamp or a metal halide lamp can be used. These light sources may be of air-cooling type or water-cooling type. It is preferred that a photopolymerization initiator is added to the UV curable resin composition. Examples of the photopolymerization initiator include acetophenones, benzophenones, Michlers's benzoyl benzoate, methyl o-benzoylbenzoate, aldoxime, tetramethylmeuram monosulfide, thioxanthones and a photosensitizer such as n-butylamine, triethylamine or tri-n-butylphosphine.

The UV curable resin composition in the invention may be a non-solvent type one or one to be diluted with a solvent.

The UV curable resin composition in the invention can contain a solvent as necessary. Examples of the solvent include an alcohol such as methanol, ethanol, 1-propanol, 2-propanol, or butanol; a ketone such as acetone, methyl ethyl ketone or cyclohexanone; an aromatic hydrocarbon such as benzene, toluene or xylene; a glycol such as ethylene glycol, propylene glycol or hexylene glycol; a glycol ether such as ethyl cellosolve, butyl cellosolve, ethyl carbitol, butyl carbitol, diethyl cellosolve, diethyl carbitol, propylene glycol monomethyl ether; N-methylpyrrolidone; dimethylformamide; an ester such as methyl lactate, ethyl lactate, methyl acetate, ethyl acetate, or amyl acetate; an ether such as diethyl ether; and water. These can be used singly or as an admixture of two or more thereof. Those having in the molecule an ether bong is preferred, and glycol ethers are preferably used.

The glycol ethers will be described later, but are not limited thereto. Examples of the glycol ethers include propylene glycol monomethyl ether, propylene glycol monoethyl ether, propylene glycol monobutyl ether, diethylene glycol dimethyl ether, ethylene glycol monomethyl ether, ethylene glycol monomethyl ether acetate, ethylene glycol monobutyl ether, ethylene glycol monoethyl ether, ethylene glycol monoethyl ether acetate and ethylene glycol diethyl ether.

The UV curable resin composition in the invention can contain microparticles as necessary in order to adjust refractive index or to provide inner scattering property. The microparticles used in the ITV curable resin composition are, for example, inorganic microparticles or organic microparticles.

Preferred examples of the inorganic microparticles include silicon-containing compounds, silicon dioxide, aluminum oxide, zirconium oxide, tin oxide, indium oxide, ITO, antimony oxide, zinc oxide, titanium dioxide, calcium carbonate, talc, clay, burned kaolin, burned calcium silicate, hydrated calcium silicate, aluminum silicate, magnesium silicate and calcium phosphate. The silicon-containing inorganic compounds or zirconium oxide are more preferred, and silicon dioxide is most preferred.

Examples of the silicon dioxide microparticles include products available on the market such as Aerosil R972, R972V, P974, R812, 200, 200V, 300, R202, OX50 and TT600 (produced by Nippon Aerosil Co., Ltd.). Examples of the zirconium oxide microparticles include products available on the market such as Aerosil R976 and R811 (produced by Nippon Aerosil Co., Ltd.).

Examples of the organic microparticles include microparticles of polymethacrylic acid methyl acrylate resin, acryl styrene based resin, polymethyl methacrylate resin, silicon based resin, polystyrene based resin, polycarbonate resin, benzoguanamine based resin, melamine based resin, polyolefin based resin, polyester based resin, polyamide based resin, polyimide based resin and polyfluoroethylene based resin.

The microparticles are preferably surface-treated with a conventional method, whereby microparticles whose dispersibility is improved are obtained.

The average particle diameter of the microparticles is preferably 0.001 to 5 μm, more preferably 0.005 to 3 μm and still more preferably 0.01 to 1 μm. Two or more kinds of the microparticles, which are different in particle diameter or refractive index, may be used. For example, it is preferred that the UV curable resin composition contains microparticles having an average primary particle diameter of 0.001 to 0.1 μm and microparticles having an average primary particle diameter of 0.1 to 5 μm. The microparticle content of the UV curable resin composition in the invention is preferably from 0.1 to 50% by weight, and more preferably from 0.5 to 30% by weight.

### (Transparent Resin Film)

In the invention, as the transparent resin film for forming on the surface a concavo-convex pattern employing the UV curable resin composition is preferably used a transparent resin film having a thickness of from 10 to 500 μm, and more preferably from 30 to 200 μm. The transparent resin film may be one prepared according to a melt casting method or one prepared according a solution casting method. Examples of the transparent resin film include films of cellulose ester (for example, cellulose triacetate, cellulose diacetate, cellulose propionate, cellulose butyrate, cellulose acetate propionate, cellulose acetate butyrate, cellulose acetate propionate butyrate or nitrocellulose), polyamide, polycarbonate, cycloolefin polymer (for example, Arton manufactured by JSR Corp., Zeonoa manufactured by Nippon Zeon Corp.), polyester (for example, polyethylene terephthalate, polyethylene naphthalate, poly-1,4-cyclohexanedimethylene terephthalate, polyethylene-1,2-diphenoxyethane-4,4′-dicarboxylate or polybutylene terephthalate), polystyrene (for example syndiotactic polystyrene), polyolefin (for example, polypropylene, polyethylene or polymethylpenetene), polysulfone, polyether sulfone, polyarylate, polyether imide, polymethyl methacrylate and polyether ketone. Cellulose ester is especially preferred.

Typical examples of the cellulose ester films available on the market include Konica Minolta TAC, KC8UX, KC4UX, KC5UX, KC8UY, KC4UY, KC12UR, KC8UCR-3, KC8UCR-4 and KC8UCR-5 (manufactured by Konica Minolta Opto, Inc.), and Fuji TAC TD80UF (manufactured by Fuji. Photofilm Co., Ltd.).

The transparent resin film preferably contains a UV absorbent. The UV absorbent absorbs light with a wavelength of not more than 400 nm, whereby durability of the transparent resin film is improved. The UV absorbent is contained in the transparent resin film in such an amount that the transmittance to a 370 nm light is preferably not more than 10%, more preferably not more than 5%, and still more preferably not more than 2%.

There is no particular restriction to the UV absorbent. Examples of the UV absorbent include oxybenzophenone based compounds, benzotriazole compounds, salicylic acid ester compounds, benzophenone compounds, cyanoacrylate compounds triazine compounds, nickel complex salts and inorganic powder. Typical examples of the UV absorbent include 5-chloro-2-(3,5-di-sec-butyl-2-hydroxylphenyl)-2H-benzotriazole, (2-2H-benzotriazole-2-yl)-6-(straight or blanched dodecyl)-4-methylphenol, 2-hydroxy-4-benzyloxybenzophenone, 2,4-benzyloxybenzophenone, and Tinuvin such as Tinuvin 109, Tinuvin 171, Tinuvin 234, Tinuvin 326, Tinuvin 327 and Tinuvin 328 which are the products of Chiba Special Chemicals Inc.

### (Photocatalyst)

In the invention, a photocatalyst layer is provided on the surface of a quartz embossing roll whose surface has a concavo-convex pattern. When the photocatalyst layer is exposed to ultraviolet rays, the photocatalyst in the photocatalyst layer, which contacts a UV curable resin layer, decomposes the surface of the UV curable resin layer, whereby the UV curable resin layer is easily peeled from the surface of the embossing roll. Therefore, residual matter is difficult to remain on the surface of the embossing roll, which is advantageous in view of productivity and film properties. Further, coatability of an antireflection layer is considered as being improved.

As the photocatalyst in the invention, there are titanium oxide, lead sulfide, zinc sulfide, tungsten oxide, iron oxide, zirconium oxide, cadmium selenide and strontium titanate. These may be used singly or as an admixture of two or more kinds thereof. These can be used together with a conventional other photocatalyst. Among the photocatalysts, titanium oxide is preferred which is inexpensive and has high photocatalytic function, chemical stability and safety.

The titanium oxide may be amorphous or of a specific crystalline structure such as rutile, anatase or brookite type. Anatase type titanium oxide is preferably used.

Formation of the photocatalyst layer is carried out according to a coating method or a gas phase method such as vacuum deposition or CVD, but the invention is not specifically limited.

Formation of the photocatalyst layer by a coating method will be explained below. A coating solution for forming a photocatalyst layer is a solution containing gel or powder of a metal oxide with a photocatalytic function such as titanium oxide.

A photocatalyst layer coating solution is not specifically limited as long as it is a solution in which powder or sol of a photocatalyst is dispersed in a solvent. The solution is preferably one which contains a silicon-containing compound, a metal oxide and/or a metal hydroxide in addition to the photocatalyst.

The silicon-containing compound is added to a photocatalyst layer coating solution in order to improve storage stability of the photocatalyst layer coating solution. As the silicon-containing compound, there is a silicon-modified resin or a silane coupling agent. As the silicon-modified resin, silicon-acryl resin and silicon-epoxy resin each being available on the market can be used, and a solution in which they are dissolved in a solvent or an emulsion in which they are dispersed in water can be also used. As the silane coupling agent, there is a compound represented by formula RSi(Y)₃ or R₂Si(Y)₂ wherein R represents an organic functional group, and Y represents a chlorine atom or an alkoxy group.

The metal oxide and/or the metal hydroxide are added to a photocatalyst layer coating solution in order to improve adhesion of the photocatalyst layer to be formed. As the metal oxide or the metal hydroxide, powder or sol of oxide or hydroxide of metals such as Pt, Rh, Nb, Cu, Sn, Ni and Fe can be used.

A solvent used for dispersing the photocatalyst, silicon-containing compound, metal oxide or metal hydroxide is not specifically limited as long as it can uniformly disperse these materials. Examples of the solvent include aromatic hydrocarbons such as benzene, toluene and xylene; aliphatic hydrocarbons such as hexane, heptane, octane and cyclohexane; ketones such as acetone, methyl ethyl ketone, methyl isobutyl ketone and cyclohexanone; esters such as ethyl acetate, propyl acetate and butyl acetate; alcohols such as methanol, ethanol, propanol and isopropanol; water and a mixture of two or more kinds thereof.

The photocatalyst layer coating solution is preferably one containing the silicon-containing compound in an amount (in terms of solid) of 0.001 to 5% by weight, sol of at least one of the metal oxide and the metal hydroxide in an amount (in terms of solid) of 0.1 to 30% by weight, and powder or sol of the photocatalyst in an amount (in terms of solid) of 0.1 to 30% by weight.

The photocatalyst layer can be formed employing a coating solution containing a photocatalyst and an inorganic binder. For example, in titanium oxide microparticles, the smaller the particle diameter of the titanium oxide microparticles is, the higher the activity of the titanium oxide microparticles. Therefore, the titanium oxide microparticles prepared according to a sol-gel method are preferably used. However, as the primary particles of the titanium oxide are smaller, the secondary particles (aggregates of the primary particles) of the titanium oxide tend to be larger, and therefore, titanium oxide sol may be used instead of the titanium oxide microparticles.

The average particle diameter of the titanium oxide microparticles is preferably from 5 to 50 nm, and more preferably from 7 to 35 nm. Titanium oxide microparticles with an average particle diameter less than 5 nm are difficult to manufacture, and titanium oxide microparticles with an average particle diameter exceeding 50 nm exhibit poor photocatalytic activity.

As the binder, partially hydrolyzed product of alkoxysilane is preferably used. The alkoxysilane is subjected to hydrolysis and polycondensation to form a polymer having in the main chain a siloxane bond represented by —Si—O—. Thereafter, organic matter is completely removed to form a film of silica, which is one kind of the inorganic binders.

Hydrolysis of alkoxysilane can be carried out by reacting the alkoxysilane in the solution in the presence of water, and a partially hydrolyzed product of alkoxysilane can be obtained by controlling the reaction. When only water is used as the solvent of the alkoxysilane solution, hydrolysis of the alkoxysilane is difficult to control, and therefore, an organic solvent containing a small amount of water is preferably used as the solvent of the alkoxysilane solution. The solvent used may be the same as denoted in the titanium oxide microparticle dispersion solution, and is preferably alcohol.

Ethyl silicate (tetraethoxysilane) is generally used as the alkoxysilane, but the invention is not limited thereto and other alkoxy silanes can be used. An alkoxysilane used for partial hydrolysis may be a monomer or an oligomer obtained by a slight hydrolysis of alkoxysilane. The oligomer is preferably dimer to hectamer, and more preferably from trimer to pentacontamer.

Partial hydrolysis of alkoxysilane is preferably carried out in the presence of an acid catalyst. The acid catalyst is preferably an inorganic acid such as sulfuric acid, nitric acid or hydrochloric acid, but an organic acid such as p-toluene sulfonic acid, formic acid, acetic acid or propionic acid can be also used.

The preferred reaction solution for partial hydrolysis contains a monomer or oligomer of alkoxysilane in an amount of 5 to 20% by weight (in terms of SiO₂), an organic solvent in an amount of 65 to 90% by weight, an acid as a catalyst in an amount of 0.05 to 0.5% by weight, and water in an amount of 4.95 to 14.5% by weight. In this reaction solution, hydrolysis is preferably carried out at a relatively low temperature of from 30 to 60° C., and particularly from 35 to 55° C., for 2 to 5 hours. Reaction conditions or composition of the reaction solution are not specifically limited, as long as a solution of a partially hydrolyzed product of alkoxysilane is obtained. A partially hydrolyzed product solution obtained after partial hydrolysis or a partially hydrolyzed product solution whose concentration is appropriately adjusted is used as a solution of a partially hydrolyzed product of alkoxysilane. The acid catalyst or water used in the hydrolysis may remain in this solution.

Aluminum alkoxide, for example, Al(OCH₃)₃, Al(OC₂H₅)₃, Al(i-OC₃H₇)₃ or Al(t-OC₄H₉)₃ may be used. The content ratio (by weight) of the titanium oxide microparticles to the inorganic binder in the photocatalyst layer is preferably from 50:50 to 80:20. The titanium oxide microparticle content less than 50% by weight provides a photocatalyst layer with poor photocatalytic activity, while the titanium oxide microparticle content exceeding 80% by weight provides a photocatalyst layer with poor strength.

The coating solution is preferably one containing as a main component a mixture of titanium oxide microparticles or sol with ceramics sol as an inorganic binder. The titanium oxide sol is a hydrolysis intermediate of titanium alkoxide obtained according to a sol-gel method. In the sol-gel method, titanium alkoxide is hydrolyzed and polymerized in the solution to obtain sol of titanium oxide or titanium hydroxide. The resulting sol can be further heated to form microparticles of titanium oxide gel. Preferred examples of the titanium alkoxide include Ti(OCH₃)₄, Ti(OC₂H₅)₄, Ti(i-OC₃H₇)₄ and Ti(t-OC₄H₉)₄.

Titanium alkoxide and metal alkoxide for an inorganic binder may be dissolved in an organic solvent, water or a mixture thereof, in place of sol or microparticles of titanium oxide. Examples of the organic solvent include alcohol such as methanol, ethanol, propanol or butanol; ethylene glycol; ethylene oxide and triethanolamine. A pre-determined amount of a catalyst for hydrolysis is added to the resulting solution. Examples of the catalyst include acids such as hydrochloric acid, sulfuric acid, nitric acid and acetic acid; an alkali metal oxide; ammonia and amines. The added amount of the catalyst may be from 0.01 to 5 parts by weight based on 100 parts by weight of titanium alkoxide. The solution obtained above is allowed to stand at from room temperature to 80° C. for several hours, whereby hydrolysis of titanium alkoxide or alkoxide of other metals is completed. The titanium alkoxide or alkoxide of other metals is hydrolyzed to obtain microparticles of hydroxide or oxide of titanium or other metals. In this case, however, it is not necessary that all alkoxides need not change to sol, and a part of the alkoxide group may remain.

The photocatalyst layer coating solution is coated on a substrate, dried, and then allowed to stand or heated at from room temperature to 200° C., whereby sol of titanium oxide or sol of other ceramics are gelled (solidified).

The coating method of the photocatalyst layer coating solution is appropriately selected. Examples thereof include a flow coating method, a spin coating method, a dip coating method, a roll coating method, a gravure coating method, a brush coating method, and a sponge coating method.

The thickness of the photocatalyst layer is from 0.01 to 10 μm, and preferably from 0.01 to 1 μm. The photocatalyst layer has a UV absorbing function. The photocatalyst layer with too high thickness tends to lower its curing efficiency, while the photocatalyst layer with too low thickness tends to lower its durability.

As a photocatalyst layer are preferably used a photocatalyst active titanium oxide layer disclosed in Japanese Patent O.P.I. Publication No. 9-249418; a layer formed from a photocatalyst coating material disclosed in Japanese Patent No. 3038599, a photocatalyst film disclosed in Japanese Patent O.P.I. Publication Nos. 11-323190 and 11-323191 or a photocatalyst coating solution disclosed in Japanese Patent O.P.I. Publication No. 2000-273355; a photocatalyst film disclosed in Japanese Patent O.P.I. Publication No. 11-269414; a photocatalyst film disclosed in Japanese Patent O.P.I. Publication No. 2000-143292; and a photocatalyst layer formed according to a method disclosed in Japanese Patent O.P.I. Publication Nos. 10-151355, 6-205977, 10-113563, 9-262482, and 11-104500.

The photocatalyst layer in the invention can be formed according to a gas phase method such as vacuum deposition or CVD. A photocatalyst layer such as a titanium oxide layer can be also formed on a substrate by plasma-processing a reactive gas containing a photocatalyst material in a plasma processing apparatus. Next, a method of forming a photocatalyst layer by the plasma processing will be explained. The photocatalyst layer in the invention is a thin layer formed by plasma-processing a reactive gas containing a photocatalyst material.

A thin photocatalyst layer formed by plasma-processing a reactive gas can be obtained for example by the following procedure. When a high frequency voltage of from 100 to 150 kHz is applied across opposed electrodes between which the reactive gas is supplied and a power of from 0.1 to 100 W/cm² is supplied across the opposed electrodes, the reactive gas is excited to generate plasma. Thus, the thin photocatalyst layer is formed applying electric field to the reactive gas.

The upper limit of high frequency voltage applied across the opposed electrodes is preferably from 200 kHz to 150 MHz, and more preferably from 800 kHz to 150 MHz. The upper limit of power applied across the opposed electrodes is preferably not more than 50 W/cm², and more preferably not more than 20 W/cm². The area (cm²) of the electrodes to which voltage is applied refers to an area where electric discharge occurs. The high frequency voltage applied across the electrodes may be a discontinuous pulse wave or a continuous sine wave, but is preferably a continuous sine wave. Simultaneous application of two high frequency voltages having different frequency is also preferred. For example, simultaneous application of a high frequency voltage of from 1 to 200 kHz and a high frequency voltage of from 800 kHz to 150 MHz is preferred.

A titanium oxide layer, which is formed according to an atmospheric pressure plasma method disclosed in Japanese Patent O.P.I. Publication Nos. 2004-68143 and 2004-84027, and WO 02/048428, can be also used as a photocatalyst layer. A photocatalyst layer, which is formed according to a method disclosed in Japanese Patent O.P.I. Publication No. 2004-249157, is preferably used.

The photocatalyst layer can contain a photosensitizer or metal compounds such as copper compounds, for example, copper acetate, copper carbonate or copper sulfate, a metal complexes and metal oxides, whereby catalytic activity can be enhanced.

The concavo-convex pattern of the embossing roll may be changed by formation of the photocatalyst layer on the embossing roll. Although the concavo-convex pattern formed through a sand blasting method may is sometimes sharp, however, the photocatalyst layer formed on the concavo-convex pattern provides an appropriate concavo-convex pattern, whereby peeling properties of the roll are improved. It is preferred that in a formation method of the photocatalyst layer, a photocatalyst layer thickness, a sand blasting method or a hydrogen fluoride processing method, appropriate conditions are selected so as to obtain an intended concavo-convex pattern film. Polymer ultraviolet absorbing agents can be preferably used which are disclosed in Japanese Patent O.P.I. Publication Nos. 2002-169020, 2002-31715 and 2002-47357.

### (Antiglaring Antireflection Film)

When an image displaying device such as a liquid crystal display receives light from outside to form a reflected image, visibility lowers markedly. In a display of a TV or a PC (personal computer), a video camera or digital camera which is used outdoors where light is very bright or a reflective liquid crystal display light used in a cellular phone which displays an image employing reflection the surface of their displaying devices is usually subjected to treatment preventing the reflected image. The treatment is divided into (i) nonreflective treatment employing interference due to multiple optical layers and (ii) antiglaring treatment in which a fine concavo-convex pattern is formed on the surface of the device to scatter incident. The former has problems in that multiple layers having a uniform thickness are necessary which increases cost. The latter antiglaring treatment is relatively inexpensive, and therefore, is used in a monitor or a large-size personal computer.

The antiglaring film is manufactured, for example, by coating on a transparent substrate a UV curable resin in which fillers are dispersed, drying to form a UV curable resin layer and then exposing to ultraviolet rays the UV curable resin layer to form a random concavo-convex pattern on the film. Hitherto, there has been made many proposals in which a fine concavo-convex pattern is formed on surface of a film used in an image displaying device to impart antiglaring properties to the film.

The antiglaring film prepared according to the method of the invention preparing the concavo-convex pattern film provides excellent antiglaring properties, and eliminates whiteness on the surface, and an image displaying device equipped with the antiglare film provides excellent visibility.

When an image display is a liquid crystal display, the antiglare film can be used as a polarizing plate protective film. The polarizing plate is generally one comprising a polarizing film comprised of a polyvinyl alcohol film on which iodine or dichromatic dye is adsorbed and a protective film laminated on at least one surface of the polarizing film. An antiglaring polarizing plate can be obtained providing on one surface of the polarizing film the antiglare optical film as described above having a concavo-convex surface. Another polarizing plate protective film, for example, a phase difference film, an optical compensation film or an optically isotropic film having an Rt of 0 nm and an R0 of 0 nm, can be provided on the other surface of the polarizing film. Preferred examples of such a polarizing plate protective film include KC8UX, KC4UX, KC5UX, KC8UY, KC4UY, KC12UR, KC8UCR-3, KC8UCR-4 and KC8UCR-5, (all produced by Konica Minolta Opt, Inc.), and Fujitac TD80UF (produced by Fuji Photo Film Co., Ltd.).

### <Antireflection Layer>

In the invention, it is preferred that the antiglaring antireflection film comprises a UV cured resin layer and provided thereon, an antireflection layer comprising a low refractive index layer containing a fluorine-containing resin or inorganic microparticles selected from complex particles in which the porous particles are covered with a cover layer or hollow particles, the hollow of which is charged with a solvent, a gas or porous substances.

A method for forming an antireflection layer is not specifically limited, and can be formed according to a sputtering method, an atmospheric pressure plasma method or a coating method. Of these methods, a coating method is preferably used. Methods to form an antireflective layer via a coating method include a method in which metal oxide powder is dispersed in a binder resin dissolved in solvents followed by coating and then drying; a method in which a polymer having a cross-linked structure is utilized as a binder resin; and a method in which an ethylenically unsaturated monomer and a photopolymerization initiator are included in a coating solution and formation of a thin layer is carried out by irradiating the same with an actinic ray.

The following shows the preferred structures of an antireflection film with antiglaring properties without the present invention being restricted thereto. Herein, the transparent resin film is preferably a cellulose ester film.

In the following description, the hard coat layer refers to a UV cured resin layer with a concave-convex surface.

Cellulose ester film/hard coat layer/low refractive index layer

Cellulose ester film/hard coat layer/high refractive index layer/low refractive index layer

Cellulose ester film/hard coat layer/intermediate refractive index layer/high refractive index layer/low refractive index layer

Cellulose ester film/thermoplastic resin layer layer/hard coat layer/low refractive index layer

Cellulose ester film/thermoplastic resin layer layer/hard coat layer/high refractive index layer/low refractive index layer

Cellulose ester film/thermoplastic resin layer layer/hard coat layer/intermediate refractive index layer/high refractive index layer/low refractive index layer

For all these films, a back coat layer is preferably provided on the surface of the cellulose ester film opposite the side coated with the hard coat layer.

In order to decrease reflectance, a hard coat film preferably has stacking layers on it, for example, a low refractive index metal oxide layer as a top layer and a high refractive index metal oxide layer as a second layer which is in between the above mentioned top layer and the hard coat layer. Further, it may have a medium refractive index metal oxide layer (a metal oxide layer of which the refractive index is controlled by using a different metal or by changing the amount of the metal) as a third layer in between the second layer and the hard coat layer. The refractive index of the high refractive index layer is preferably from 1.55 to 2.30 and more preferably from 1.57 to 2.20. The refractive index of the medium refractive index layer is controlled to be an intermediate value between a refractive index of a cellulose ester substrate (around 1.5) and of a high refractive index layer. The refractive index of the medium refractive index layer is preferably from 1.55 to 1.80. The refractive index of the low refractive index layer is preferably from 1.3 to 1.44, and more preferably from 1.35 to 1.41. The thickness of each layer is preferably from 5 nm to 0.5 μm, more preferably from 10 nm to 0.3 μm and most preferably from 30 nm to 0.2 μm.

In the CIE-LAB color system, a reflection color phase satisfies −10≦a*≦+10, −15≦b*≦+15 and 1≦L≦10, and a transmission color phase satisfies −2≦a* and b*≦2 (which is colorless). These inequalities can be attained adjusting the refractive index or thickness of each refractive index layer.

The haze of a metal oxide layer is preferably not more than 5%, more preferably not more than 3% and most preferably not more than 1%. The pencil hardness grade of a metal oxide layer under a weight of 1 kg is preferably 3H or higher and most preferably 4H or higher. When a metal oxide layer is formed by a coating method, inorganic microparticles and a binder polymer are preferably incorporated therein.

Complex particles constituted of porous particles and provided on the surface, a cover layer or hollow particles whose hollow is charged with solvent, gas or porous substances, which are preferably used in the low refractive index layer, will be explained below.

Inorganic microparticles are (I) complex particles constituted of porous particles and provided on the surface, a cover layer or (II) hollow particles, the interior of which is provided with a hollow and the hollow is charged with contents such as a solvent, a gas or a porous substance. Herein, at least either (I) complex particles or (II) hollow particles are contained in the low refractive index layer, and the both of them may be contained in the low refractive index layer. Herein, hollow particles are particles the interior of which is provided with a hollow which is surrounded with the particle wall and charged with the contents such as a solvent, a gas or a porous substance in the preparation thereof.

The mean particle size of such inorganic microparticles is preferably in a range of 5 to 300 nm and preferably of 10 to 200 nm. The mean particle size of inorganic microparticles utilized is appropriately selected depending on the thickness of the formed transparent cover film and is preferably in a range of ⅔ to 1/10 of the layer thickness of the transparent cover film of such as a formed low refractive index layer. These inorganic microparticles are preferably utilized in a state of being dispersed in a suitable medium to form a low refractive index layer. As dispersing medium, water, alcohol (such as methanol, ethanol and isopropanol), ketone (such as methyl ethyl ketone and methyl isobutyl ketone) and ketone alcohol (such as diacetone alcohol) are preferable.

The thickness of the cover layer of the complex particles or the thickness of the particle wall of hollow particles is preferably in a range of 1 to 20 nm and more preferably in a range of 2 to 15 nm. In the case of the complex particles, when a thickness of the cover layer is less than 1 nm, a particle may not be completely covered to allow such as silicate monomer or oligomer having a low polymerization degree as a coating component described later to immerse into the interior of the complex particles resulting in decrease of porosity of the interior, whereby an effect of a low refractive index may not be obtained. Further, when the thickness of the cover layer is over 20 nm, the aforesaid silicate monomer or oligomer never immerses into the interior, however, the porosity (a pore volume) of complex particles may decrease, resulting in an insufficient effect of a low refractive index. Further, in the case of the hollow particles, particle shape may not be kept when a thickness of the particle wall is less than 1 nm, while an effect of a low refractive index may not be obtained when a thickness of the particle wall is not less than 20 nm.

The cover layer of the complex particle or the particle wall of the hollow particle is preferably comprised of silica as a primary component. Further, components other than silica may be incorporated and specific examples include compounds such as Al₂O₃, B₂O₃, TiO₂, ZrO₂, SnO₂, CeO₂, P₂O₃, Sb₂O₃, MoO₃, ZnO₂/and WO₃. Porous particles to constitute a complex particle include those comprised of silica, those comprised of silica and an inorganic compound other than silica and those comprised of such as CaF₂, NaF, NaAlF₆ and MgF. Among them, specifically preferable are porous particles comprised of a complex oxide of silica and inorganic compounds other than silica. Inorganic compounds other than silica include one type or at least two types of compounds such as Al₂O₃, B₂O₃, TiO₂, ZrO₂, SnO₂, CeO₂, P₂O₃, Sb₂O₃, MoO₃, ZnO₂ and WO₃.

In such porous particles, the mole ratio MOₓ/SiO₂ is preferably in a range of 0.0001 to 1.0 and more preferably of 0.001 to 0.3, when silica is represented by SiO₂ and an inorganic compound other than silica is represented by an equivalent oxide (MOₓ). Porous particle having mole ratio MOₓ/SiO₂ of less than 0.0001 is difficult to be prepared and the pore volume is small to unable preparation of a particle having a low refractive index. Further, when mole ratio MOₓ/SiO₂ of porous particles is over 1.0, the pore volume becomes large due to a small ratio of silica and it may be further difficult to prepare a particle having a low refractive index.

A pore volume of such a porous particle is preferably in a range of 0.1 to 1.5 ml/g and more preferably of 0.2 to 1.5 ml/g. When the pore volume is less than 0.1 ml/g, a particle having a sufficiently decreased refractive index cannot be prepared, while, when it is over 1.5 ml/g, strength of a particle is decreased and strength of the obtained cover film may be decreased.

Herein, the pore volume of such a porous particle can be determined by a mercury pressurized impregnation method. Further, content of hollow particles includes such as a solvent, a gas and a porous substance which have been utilized at preparation of the particle. In a solvent, such as a non-reacted substance of a particle precursor which is utilized at hollow particle preparation and a utilized catalyst may be contained. Further, porous substances include those comprising compounds exemplified in the aforesaid porous particle. These contents may be those comprising single component or mixture of plural components.

As a manufacturing method of such hollow particles, a preparation method of complex oxide colloidal particles, disclosed in paragraph Nos. [0010]-[0033] of JP-A No. 7-133105 (JP-A refers to Japanese Patent Publication Open to Public Inspection), is suitably applied. Specifically, in the case of a complex particle being comprised of silica and an inorganic compound other than silica, the hollow particle is manufactured according to the following first to third processes.

### First Process: Preparation of Porous Particle Precursor

In the first process, alkaline aqueous solutions of a silica raw material and of an inorganic compound raw material other than silica are independently prepared or a mixed aqueous solution of a silica raw material and an inorganic compound raw material other than silica is prepared, in advance, and this aqueous solution is gradually added into an alkaline aqueous solution having a pH of not less than 10 while stirring depending on the complex ratio of the aimed complex oxide, whereby a porous particle precursor is prepared.

As a silica raw material, silicate of alkali metal, ammonium or organic base is utilized. As silicate of alkali metal, utilized are sodium silicate (water glass) and potassium silicate. Organic base includes quaternary ammonium salt such as tetraethylammonium salt; and amines such as monoethanolamine, diethanolamine and triethanolamine. Herein, an alkaline solution, in which such as ammonia, quaternary ammonium hydroxide or an amine compound is added in a silicic acid solution, is also included in silicate of ammonium or silicate of organic base.

Further, as a raw material of an inorganic compound other than silica, utilized is an alkali-soluble inorganic compound. Specific examples include oxoacid of an element selected from such as Al, B, Ti, Zr, Sn, Ce, P, Sb, Mo, Zn and W; alkali metal salt, alkaline earth metal salt, ammonium salt and quaternary ammonium salt of said oxoacid. More specifically, sodium aluminate, sodium tetraborate, ammonium zirconyl carbonate, potassium antimonite, potassium stannate, sodium alminosilicate, sodium molybdate, cerium ammonium nitrate and sodium phosphate are suitable.

The pH value of a mixed aqueous solution changes simultaneously with addition of these aqueous solutions, however, operation to control the pH value into a specific range is not necessary. The aqueous solution finally takes a pH value determined by the types and the mixing ratio of inorganic oxide. At this time, the addition rate of an aqueous solution is not specifically limited. Further, dispersion of a seed particle may be also utilized as a starting material at the time of manufacturing of complex oxide particles. Said seed particles are not specifically limited, however, particles of inorganic oxide such as SiO₂, Al₂O₃, TiO₂ or ZrO₂ or complex oxide thereof are utilized, and generally sol thereof can be utilized. Further, a porous particle precursor dispersion prepared by the aforesaid manufacturing method may be utilized as a seed particle dispersion. In the case of utilizing a seed particle dispersion, after the pH of a seed particle dispersion is adjusted to not lower than 10, an aqueous solution of the aforesaid compound is added into said seed particle dispersion while stirring. In this case pH control of dispersion is not necessarily required. By utilizing seed particles in this manner, it is easy to control the particle size of prepared porous particles, and particles having a uniform size distribution can be obtained.

A silica raw material and an inorganic compound raw material, which were described above, have a high solubility at alkaline side. However, when the both are mixed in pH range showing this high solubility, the solubility of an oxoacid ion such as a silicic acid ion and an aluminic acid ion will decrease, resulting in precipitation of these complex products to form particles or to be precipitated on a seed particle causing particle growth. Therefore, at the time of precipitation and growth of particles, pH control in a conventional method is not necessarily required.

A complex ratio of silica and an inorganic compound other than silica is preferably in a range of 0.05 to 2.0 and more preferably of 0.2 to 2.0, based on mole ratio MOₓ/SiO₂, when an inorganic compound other than silica is converted to oxide (MOₓ). In this range, the smaller is the ratio of silica, increases the pore volume of porous particles. However, a pore volume of porous particles barely increases even when the mole ratio is over 2.0. On the other hand, a pore volume becomes small when the mole ratio is less than 0.05. In the case of preparing hollow particles, mole ratio of MOₓ/SiO₂ is preferably in a range of 0.25 to 2.0.

Second Process: Elimination of Inorganic Compounds Other than Silica from Porous Particles

In the second process, at least a part of inorganic compounds other than silica (elements other than silica and oxygen) is selectively eliminated from the porous particle precursor prepared in the aforesaid first process. As a specific elimination method, inorganic compounds in a porous particle precursor are dissolving eliminated by use of such as mineral acid and organic acid, or ion-exchanging eliminated by being contacted with cationic ion-exchange resin.

Herein, a porous particle precursor prepared in the first process is a particle having a network structure in which silica and an inorganic compound element bond via oxygen. In this manner, by eliminating inorganic compounds (elements other than silica and oxygen) from a porous particle precursor, porous particles, which are more porous and have a large pore volume, can be prepared. Further, hollow particles can be prepared by increasing the elimination amount of inorganic compound (elements other than silica and oxygen) from a porous particle precursor.

Further, in advance to elimination of inorganic compounds other than silica from a porous particle precursor, it is preferable to form a silica protective film by adding a silicic acid solution which contains a silane compound having a fluorine substituted alkyl group, and is prepared by dealkalization of alkali metal salt of silica; or a hydrolyzable organosilicon compound, in a porous particle precursor dispersion prepared in the first process. The thickness of a silica protective film is 0.5-15 nm. Herein, even when a silica protective film is formed, since the protective film in this process is porous and has a thin thickness, it is possible to eliminate the aforesaid inorganic compounds other than silica from a porous particle precursor.

By forming such a silica protective film, the aforesaid inorganic compounds other than silica can be eliminated from a porous particle precursor while keeping the particle shape as it is. Further, at the time of forming a silica cover layer described later, the pore of porous particles is not blocked by a cover layer, and thereby the silica cover layer described later can be formed without decreasing the pore volume. Herein, when the amount of inorganic compound to be eliminated is small, it is not necessary to form a protective film because the particles will never be broken.

Further, in the case of preparation of hollow particles, it is preferable to form this silica protective film. At the time of preparation of hollow particles, a hollow particle precursor, which is comprised of a silica protective film, a solvent and insoluble porous solid within said silica protective film, is obtained when inorganic compounds are eliminated, and hollow particles are formed, by making a particle wall from a formed cover layer, when the cover layer described later is formed on said hollow particle precursor.

The amount of a silica source added to form the aforesaid silica protective film is preferably in a range to maintain the particle shape. When the amount of a silica source is excessively large, it may become difficult to eliminate inorganic compounds other than silica from a porous particle precursor because a silica protective film becomes excessively thick. As a hydrolizable organosilicon compound utilized to form a silica protective film, alkoxysilane represented by formula RₙSi(OR′)₄₋ₙ [R, R′: a hydrocarbon group such as an alkyl group, an aryl group, a vinyl group and an acryl group; n=0, 1, 2 or 3] can be utilized. Fluorine-substituted tetraalkoxysilane, such as tetramethoxysilane, tetraethoxysilane and tetraisopropoxysilane, is specifically preferably utilized.

As an addition method, a solution, in which a small amount of alkali or acid as a catalyst is added into a mixed solution of these alkoxysilane, pure water and alcohol, is added into the aforesaid dispersion of porous particles, and silicic acid polymer formed by hydrolysis of alkoxysilane is precipitated on the surface of inorganic oxide particles. At this time, alkoxysilane, alcohol and a catalyst may be simultaneously added into the dispersion. As an alkali catalyst, ammonia, hydroxide of alkali metal and amines can be utilized. Further, as an acid catalyst, various types of inorganic acid and organic acid can be utilized.

In the case that a dispersion medium of a porous particle precursor is water alone or has a high ratio of water to an organic solvent, it is also possible to form a silica protective film by use of a silicic acid solution. In the case of utilizing a silicic acid solution, a predetermined amount of a silicic acid solution is added into the dispersion and alkali is added simultaneously, to precipitate silicic acid solution on the porous particle surface. Herein, a silica protective film may also be formed by utilizing a silicic acid solution and the aforesaid alkoxysilane in combination.

### Third Process: Formation of Silica Cover Layer

In the third process, by addition of such as a hydrolyzable organosilicon compound containing a silane compound provided with a fluorine substituted alkyl group, or a silicic acid solution, into a porous particle dispersion (into a hollow particle dispersion in the case of hollow particles), which is prepared in the second process, the surface of particles is covered with a polymer substance of such as a hydrolyzable organosilicon compound or a silicic acid solution to form a silica cover layer.

As a hydrolyzable organosilicon compound utilized for formation of a silica cover layer, alkoxysilane represented by formula RₙSi(OR′)₄₋ₙ [R, R′: a hydrocarbon group such as an alkyl group, an aryl group, a vinyl group and an acryl group; n=0, 1, 2 or 3], as described before, can be utilized. Tetraalkoxysilane such as tetramethoxysilane, tetraethoxysilane and tetraisopropoxysilane are specifically preferably utilized.

As an addition method, a solution, in which a small amount of alkali or acid as a catalyst is added into a mixed solution of these alkoxysilane, pure water and alcohol, is added into the aforesaid dispersion of porous particles (a hollow particle precursor in the case of hollow particles), and silicic acid polymer formed by hydrolysis of alkoxysilane is precipitated on the surface of porous particles (a hollow particle precursor in the case of hollow particles). At this time, alkoxysilane, alcohol and a catalyst may be simultaneously added into the dispersion. As an alkali catalyst, ammonia, hydroxide of alkali metal and amines can be utilized. Further, as an acid catalyst, various types of inorganic acid and organic acid can be utilized.

In the case that a dispersion medium of porous particles (a hollow particle precursor in the case of hollow particles) is water alone or a mixed solution of water with an organic solvent having a high ratio of water to an organic solvent, it is also possible to form a cover layer by use of a silicic acid solution. A silicic acid solution is an aqueous solution of lower polymer of silicic acid which is formed by ion-exchange and dealkalization of an aqueous solution of alkali metal silicate such as water glass.

A silicic acid solution is added into a dispersion of porous particles (a hollow particle precursor in the case of hollow particles), and alkali is simultaneously added to precipitate silicic acid lower polymer on the surface of porous particles (a hollow particle precursor in the case of hollow particles). Herein, silicic acid solution may be also utilized in combination with the aforesaid alkoxysilane to form a cover layer. The addition amount of an organosilicon compound or a silicic acid solution, which is utilized for cover layer formation, is as much as to sufficiently cover the surface of colloidal particles and the solution is added into a dispersion of porous particles (a hollow particle precursor in the case of hollow particles) at an amount to make a thickness of the finally obtained silica cover layer of 1 to 20 nm. Further, in the case that the aforesaid silica protective film is formed, an organosilicon compound or a silicic acid solution is added at an amount to make a thickness of the total of a silica protective film and a silica cover layer of 1 to 20 nm.

Next, a dispersion of particles provided with a cover layer is subjected to a thermal treatment. By a thermal treatment, in the case of porous particles, a silica cover layer, which covers the surface of porous particles, becomes minute to prepare a dispersion of complex particles comprising porous particles covered with a silica cover layer. Further, in the case of a hollow particle precursor, the formed cover layer becomes minute to form a hollow particle wall, whereby a dispersion of hollow particles provided with a hollow, the interior of which is filled with a solvent, a gas or a porous solid, is prepared.

Thermal treatment temperature at this time is not specifically limited provided being so as to block micro-pores of a silica cover layer, and is preferably in a range of 80 to 300° C. At a thermal treatment temperature of lower than 80° C., a silica cover layer may not become minute to completely block the micro-pores or the treatment time may become long. Further, when a prolonged treatment at a thermal treatment temperature of higher than 300° C. is performed, particles may become minute and an effect of a low refractive index may not be obtained.

A refractive index of inorganic particles prepared in this manner is less than 1.44, which is low. It is estimated that the refractive index becomes low because such inorganic particles maintain porous property in the interior of porous particles or the interior is hollow.

As a binder matrix for the low refractive index layer, a fluorine containing resin (hereinafter also referred to as fluorine containing resin before cross-linking), which undergoes crosslinking by heat or ionizing radiation, is preferably used.

Preferably listed as fluorine containing resins before cross-linking are fluorine containing copolymers which are formed employing fluorine containing vinyl monomers and monomers having a crosslinking group. Listed as specific examples of the above fluorine containing vinyl monomer units are fluoroolefins (for example, fluoroethylene, vinylidene fluoride, tetrafluoroethylene, hexafluoroethylene, hexafluoropropylene, perfluoro-2,2-dimethyl-1,3-dioxol), partially or completely fluorinated alkyl ester derivatives of (meth)acrylic acid (for example, BISCOAT 6FM (produced by Osaka Organic Chemical Industry Ltd.) and M-2020 (produced by Daikin Industries, Ltd.), and completely or partially fluorinated vinyl ethers.

Listed as monomers to provide a crosslinking group are vinyl monomers previously having a crosslinking functional group in the molecule, such as glycidyl methacrylate, vinyltrimethoxysilane, γ-methacryloyloxypropyltrimethoxy-silane, or vinyl glycidyl ether, as well as vinyl monomers having a carboxyl group, a hydroxyl group, an amino group, or a sulfone group (for example, (meth)acrylic acid, methylol (meth)acrylate, hydroxyalkyl(meth)acrylate, allyl acrylate, hydroxyalkyl vinyl ether, and hydroxyalkyl allyl ether). JP-A Nos. 10-25388 and 10-147739 describe that a crosslinking structure is introduced into the latter by adding compounds having a group which reacts with the functional group in the polymer and at least one reacting group. Listed as examples of the crosslinking group are a acryloyl, methacryloyl, isocyanate, epoxy, aziridine, oxazoline, aldehyde, carbonyl, hydrazine, carboxyl, methylol or active methylene group.

When fluorine containing polymers undergo thermal crosslinking due to the presence of a thermally reacting crosslinking group or the combinations of an ethylenic unsaturated group with thermal radical generating agents or an epoxy group with a heat generating agent, they are of a heat curable type, while fluorine containing polymers in combination with an ethylenic unsaturated group and photo-radical generating agents or with an epoxy group and photolytically acid generating agents undergo crosslinking by exposure to radiation (preferably ultraviolet radiation and electron beams), they are of an ionizing radiation curable type.

Further, employed as a fluorine containing resins prior to coating may be fluorine containing copolymers which are prepared by employing the above monomers with fluorine containing vinyl monomers, and monomers other than monomers to provide a crosslinking group in addition to the above monomers. Monomers capable being simultaneously employed are not particularly limited. Those examples include olefins (ethylene, propylene, isoprene, vinyl chloride, and vinylidene chloride); acrylates (methyl acrylate, ethyl acrylate, and 2-ethylhexyl acrylate); methacrylates (methyl methacrylate, ethyl methacrylate, butyl methacrylate, and ethylene glycol dimethacrylate); styrene derivatives (styrene, divinylbenzene, vinyltoluene, and α-methylstyrene); vinyl ethers (methyl vinyl ether); vinyl esters (vinyl acetate, vinyl propionate, and vinyl cinnamate); acrylamides (N-tert-butylacrylamide and N-cyclohexylacrylamide); methacrylamides; and acrylonitrile derivatives.

Further, in order to provide desired lubricating properties and antistaining properties, it is also preferable to introduce a polyorganosiloxane skeleton or a perfluoropolyether skeleton into fluorine containing copolymers. The above introduction is performed, for example, by polymerization of the above monomers with polyorganosiloxane and perfluoroether having, at the end, an acryl group, a methacryl group, a vinyl ether group, or a styryl group and reaction of polyorganosiloxane and perfluoropolyether having a functional group.

The used ratio of each monomer to form the fluorine containing copolymers prior to coating is as follows. The ratio of fluorine containing vinyl monomers is preferably 20 to 70 mol percent, but is more preferably 40 to 70 mol percent; the ratio of monomers to provide a crosslinking group is preferably 1 to 20 mol percent, but is more preferably 5 to 20 mol percent, and the ratio of the other monomers simultaneously employed is preferably 10 to 70 mol percent, but is more preferably 10 to 50 mol percent.

It is possible to obtain the fluorine containing copolymers by polymerizing these monomers employing methods such as a solution polymerization method, a block polymerization method, an emulsion polymerization method or a suspension polymerization method.

The fluorine containing resins prior to cross-linking are commercially available and it is possible to employ commercially available products. Listed as examples of the fluorine containing resins prior to coating are SAITOP (produced by Asahi Glass Co., Ltd.), TEFLON (a registered trade name) AD (produced by Du Pont), vinylidene polyfluoride, RUMIFRON (produced by Asahi Glass Co., Ltd.), and OPSTAR (produced by JSR).

The dynamic friction coefficient and contact angle to water of the low refractive index layer composed of crosslinked fluorine containing resins are in the range of 0.03 to 0.15 and in the range of 90 to 120 degrees, respectively.

The low refractive-index layer containing the crosslinked fluorine containing resin as its constituent may contains the above-mentioned inorganic particles.

Moreover, as a hinder matrix for other low refractive-index layers, various kinds of sol gel components can also be used. As the sol gel components, a metal alcoholate (such as alcoholate of silane, titanium, aluminum or zirconium), an organoalkoxy metal compound, and their hydrolyzate can be used. In particular, alkoxysilane, organoalkoxysilane and its hydrolyzate are preferred.

As these examples, tetra-alkoxy silane (tetramethoxysilane, tetraethoxysilane, etc.), alkyl tri alkoxy silane (methyltrimethoxysilane, ethyltrimethoxysilane, etc.), aryltrialkoxy silane (phenyltrimethoxsilane etc.), dialkyldialkoxy silane, diaryldialkoxy silane, etc. are may be listed. Moreover, organoalkoxy silane having various functional groups (vinyl tri alkoxy silane, methylvinydialkoxy silane, γ-glycidyloxypropyltrialkoxy silane, γ-glycidyloxypropylmethyldialkoxy silane, β-(3,4-epoxycyclohexyl)ethyltrialkoxy silane, γ-methacryloyloxypropyltrialkoxy silane, γ-aminopropyl tri alkoxy silane, γ-mercaptopropyltrialkoxy silane, γ-chloropropyltrialkoxy silane, etc.), perfluoroalkylgroup containing silane compound (for example, (heptadecafluoro-1,1,2,2-tetradecyl)triethoxysilane, 3,3,3-trifluoropropyl-trimethoxysilane etc.), fluoroalkylether group containing silane compound may be preferably used. Especially, use of fluorine-containing silane compound is preferred in providing a layer with a low refractive index or a water and oil repelling property.

As an acid catalyst for the above-described hydrolyzate, an inorganic acid such as hydrochloric acid or nitric acid or an organic acid such as formic acid, acetic acid, trichloroacetic acid, oxalic acid or citric acid can be used. In order to improve physical properties of the low refractive index layer, a coating composition thereof preferably contains a metal compound.

Examples of the metal compound include a zirconium compound such as such as zirconium tri-n-butoxyethylacetoacetate, zirconium di-n-butoxybis(ethylacetoacetate), zirconium n-butoxytris(ethylacetoacetate), zirconium tetrakis-(n-propylacetoacetate), zirconium tetrakis-(acetylacetoacetate) or zirconium tetrakis(ethyl acetoacetate); a titanium compound such as titanium diisopropoxybis-(ethylacetoacetate), titanium diisopropoxy-bis(acetylacetate) or titanium diisopropoxy-bis(acetylacetone); and an aluminum compound such as aluminum diisopropoxyethylacetoacetate, aluminum diisopropoxyacetylacetonate, aluminum isopropoxy-bis(ethylacetoacetate), aluminum isopropoxy-bis(acetylacetonate), aluminum tris(ethylacetoacetate), aluminum tris(ethylacetonate), aluminum tris(acetylacetonate) and aluminum monoacetylacetonatobis(ethylacetoacetate).

Among these metal compounds, zirconium tri-n-butoxyethylacetoacetate, titanium diisopropoxy-bis(acetylacetate), aluminum diisopropoxyethylacetoacetate and aluminum tris(ethylacetoacetate) are preferred.

These metal compounds may be used singly or as a mixture of two or more kinds thereof. The partially hydrolyzed product of these metal compounds can be used. The metal compound content of the coating composition is preferably from 0.01 to 50% by weight, and more preferably from 01 to 50% by weight, and still more preferably from 0.5 to 10% by weight, based on the content of organosilane as a material of the sol.

It is preferred that the low refractive index layer incorporates polymers in an amount of 5 to 50 percent by weight. The above polymers exhibit functions such that minute particles are subjected to adhesion and the structure of the above low refractive index layer is maintained. The used amount of the polymers is controlled so that without filing voids, it is possible to maintain the strength of the low refractive index layer. The amount of the polymers is preferably 10 to 30 percent by weight of the total weight of the low refractive index layer.

In order to achieve adhesion of minute particles employing polymers, it is preferred that (1) polymers are combined with surface-processing agents of minute particles, (2) a polymer shell is formed around a minute particle used as a core, or (3) polymers are employed as a binder among minute particles. The polymers which are combined with the surface processing agents in (1) are preferably the shell polymers of (2) or binder polymers of (3). It is preferred that the polymers of (2) are formed around the minute particles employing a polymerization reaction prior to preparation of the low refractive index layer liquid coating composition. It is preferred that the polymers of (3) are formed employing a polymerization reaction during or after coating of the low refractive index layer while adding their monomers to the above low refractive index layer coating composition. It is preferred that at least two of (1), (2), and (3) or all are combined and employed. Of these, it is particularly preferable to practice the combination of (1) and (3) or the combination of (1), (2), and (3). (1) Surface treatment, (2) shell, and (3) binder will now successively be described in that order.

### (1) Surface Treatment

It is preferred that minute particles (especially, minute inorganic particles) are subjected to a surface treatment to improve affinity with polymers. These surface treatments are classified into a physical surface treatment such as a plasma discharge treatment or a corona discharge treatment and a chemical surface treatment employing coupling agents. It is preferred that the chemical surface treatment is only performed or the physical surface treatment and the chemical surface treatment are performed in combination. Preferably employed as coupling agents are organoalkoxymetal compounds (for example, titanium coupling agents and silane coupling agents). In cases in which minute particles are composed of SiO₂, it is possible to particularly effectively affect a surface treatment employing the silane coupling agents. As specific examples of the silane coupling agents, preferably employed are those listed above.

The surface treatment employing the coupling agents is achieved in such a manner that coupling agents are added to a minute particle dispersion and the resulting mixture is allowed to stand at room temperature −60° C. for several hours-10 days. In order to accelerate a surface treatment reaction, added to a dispersion may be inorganic acids (for example, sulfuric acid, hydrochloric acid, nitric acid, chromic acid, hypochloric acid, boric acid, orthosilicic acid, phosphoric acid, and carbonic acid), or salts thereof (for example, metal salts and ammonium salts).

### (2) Shell

Shell forming polymers are preferably polymers having a saturated hydrocarbon as a main chain. Polymers incorporating fluorine atoms in the main chain or the side chain are preferred, while polymers incorporating fluorine atoms in the side chain are more preferred. Acrylates or methacrylates are preferred and esters of fluorine-substituted alcohol with polyacrylic acid or methacrylic acid are most preferred. The refractive index of shell polymers decreases as the content of fluorine atoms in the polymer increases. In order to lower the refractive index of a low refractive index layer, the shell polymers incorporate fluorine atoms in an amount of preferably 35-80 percent by weight, but more preferably 45-75 percent by weight. It is preferred that fluorine containing polymers are synthesized via the polymerization reaction of fluorine atom containing ethylenic unsaturated monomers. Listed as examples of fluorine atom containing ethylenic unsaturated monomers are fluorolefins (for example, fluoroethylene, vinylidene fluoride, tetrafluoroethylene, hexafluoropropylene, perfluoro-2,2-dimethyl-1,3-dixol), fluorinated vinyl ethers and esters of fluorine substituted alcohol with acrylic acid or methacrylic acid.

Polymers to form the shell may be copolymers having repeating units with and without fluorine atoms. It is preferred that the units without fluorine atoms are prepared employing the polymerization reaction of ethylenic unsaturated monomers without fluorine atoms. Listed as examples of ethylenic unsaturated monomers without fluorine atoms are olefins (for example, ethylene, propylene, isoprene, vinyl chloride, and vinylidene chloride), acrylates (for example, methyl acrylate, ethyl acrylate, and 2-ethylhexyl acrylate), methacrylates (for example, methyl methacrylate, ethyl methacrylate, butyl methacrylate, and ethylene glycol dimethacrylate), styrenes and derivatives thereof (for example, styrene, divinylbenzene, vinyltoluene, and α-methylstyrene), vinyl ethers (for example, methyl vinyl ether), vinyl esters (for example, vinyl acetate, vinyl propionate, and vinyl cinnamate), acrylamides (for example, N-tetrabutylacrylamide and N-cyclohexylacrylamide), as well as methacrylamide and acrylonitrile.

In the case of (3) in which binder polymers described below are simultaneously used, a crosslinking functional group may be introduced into shell polymers and the shell polymers and binder polymers are chemically bonded via crosslinking. Shell polymers may be crystalline. When the glass transition temperature (Tg) of the shell polymer is higher than the temperate during the formation of a low refractive index layer, micro-voids in the low refractive index layer are easily maintained. However, when Tg is higher than the temperature during formation of the low refractive index layer, minute particles are not fused and occasionally, the resulting low refractive index layer is not formed as a continuous layer (resulting in a decrease in strength). In such a case, it is desirous that the low refractive index layer is formed as a continuous layer simultaneously employing the binder polymers of (3). A polymer shell is formed around the minute particle, whereby a minute core/shell particle is obtained. A core composed of a minute inorganic particle is incorporated preferably 5-90 percent by volume in the minute core/shell particle, but more preferably 15-80 percent by volume. At least two types of minute core/shell particle may be simultaneously employed. Further, inorganic particles without a shell and core/shell particles may be simultaneously employed.

### (3) Binders

Binder polymers are preferably polymers having saturated hydrocarbon or polyether as a main chain, but is more preferably polymers having saturated hydrocarbon as a main chain. The above binder polymers are subjected to crosslinking. It is preferred that the polymers having saturated hydrocarbon as a main chain is prepared employing a polymerization reaction of ethylenic unsaturated monomers. In order to prepare crosslinked binder polymers, it is preferable to employ monomers having at least two ethylenic unsaturated groups.

Listed as examples of monomers having at least two ethylenic unsaturated groups are esters of polyhydric alcohol with (meth)acrylic acid (for example, ethylene glycol di(meth)acrylate, 1,4-dicyclohexane diacrylate, pentaerythritol tetra(meth)acrylate, pentaerythritol (meth)acrylate, trimethylolpropane tri(meth)acrylate, trimethylolethane tri(meth)acrylate, dipentaerythritol tetra(meth)acrylate, dipentaerythritol penta(meth)acrylate, pentaerythritol hexa (meth)acrylate, 1,2,3-cyclohexane tetramethacrylate, polyurethane polyacrylate, and polyester polyacrylate); vinylbenzene and derivatives thereof (for example, 1,4-divinylbenzene and 4-vinylbenzoic acid-2-acryloylethyl ester, and 1,4-divinylcyclohexane); vinylsulfones (for example, divinylsulfone); acrylamides (for example, methylenebisacrylamide); and methacrylamides.

It is preferred that polymers having polyether as a main chain are synthesized employing a ring opening polymerization reaction. A crosslinking structure may be introduced into binder polymers employing a reaction of crosslinking group instead of or in addition to monomers having at least two ethylenic unsaturated groups. Listed as examples of the crosslinking functional groups are an isocyanate group, an epoxy group, an aziridine group, an oxazoline group, an aldehyde group, a carbonyl group, a hydrazine group, a carboxyl group, a methylol group, and an active methylene group. It is possible to use, as a monomer to introduce a crosslinking structure, vinylsulfonic acid, acid anhydrides, cyanoacrylate derivatives, melamine, ether modified methylol, esters and urethane. Functional groups such as a block isocyanate group, which exhibit crosslinking properties as a result of the decomposition reaction, may be employed. The crosslinking groups are not limited to the above compounds and include those which become reactive as a result of decomposition of the above functional group.

Employed as polymerization initiators used for the polymerization reaction and crosslinking reaction of binder polymers are heat polymerization initiators and photopolymerization initiators, but the photopolymerization initiators are more preferred. Examples of photopolymerization initiators include acetophenones, benzoins, benzophenones, phosphine oxides, ketals, antharaquinones, thioxanthones, azo compounds, peroxides, 2,3-dialkyldiones, disulfide compounds, fluoroamine compounds, and aromatic sulfoniums. Examples of acetophenones include 2,2-diethoxyacetophenone, p-dimethylacetophenone, 1-hydroxydimethyl phenyl ketone, 1-dihydroxycyclohexyl phenyl ketone, 2-methyl-4-methylthio-2-morpholinopropiophene, and 2-benzyl-2-dimethylamino-1-(4-morpholinophenyl)-butanone. Examples of benzoins include benzoin ethyl ether and benzoin isopropyl ether. Examples of benzophenones include benzophenone, 2,4-dichlorobenzophenone, 4,4-dichlorobenzophenone, and p-chlorobenzophenone. Examples of phosphine oxides include 2,4,6-trimethylbenzoyl-diphenylphosphine oxide.

It is preferred that binder polymers are formed in such a manner that monomers are added to a low refractive index layer liquid coating composition and the binder polymers are formed during or after coating of the low refractive index layer utilizing a polymerization reaction (if desired, further crosslinking reaction). A small amount of polymers (for example, polyvinyl alcohol, polyoxyethylene, polymethyl methacrylate, polymethyl acrylate, diacetyl cellulose, triacetyl cellulose, nitrocellulose, polyester, and alkyd resins) may be added to the low refractive index layer liquid coating composition.

Further, it is preferred to add slipping agents to the low refractive index layer or other refractive index layers. By providing desired slipping properties, it is possible to improve abrasion resistance. Preferably employed as slipping agents are silicone oil and wax materials. For example, preferred are the compounds represented by the formula below.

R₁COR₂ Formula

In the above formula, R₁ represents a saturated or unsaturated aliphatic hydrocarbon group hang at least 12 carbon atoms. R₁ is preferably an alkyl group or an alkenyl group and is more preferably an alkyl group or an alkenyl group having at least 16 carbon atoms. R₂ represents —OM₁ group (M₁ represents an alkaline metal such as Na or K), —OH group, —NH₂ group, or —OR₃ group (R₃ represents a saturated or unsaturated aliphatic hydrocarbon group having at least 12 carbon atoms and is preferably an alkyl group or an alkenyl group). R₂ is preferably —OH group, —NH₂ group or OR₃ group.

Preferably employed may be higher fatty acids or derivatives thereof such as behenic acid, stearic acid amide, or pentacosanoic acid or derivatives thereof and natural products such as carnauba wax, beeswax, or montan wax, which incorporate a large amount of such components. Further listed may be polyorganosiloxane disclosed in Japanese Patent Publication No. 53-292, higher fatty acid amides discloses in U.S. Pat. No. 4,275,146, higher fatty acid esters (esters of a fatty acid having 10 to 24 carbon atoms and alcohol having 10 to 24 carbon atoms) disclosed in Japanese Patent Publication No. 58-35341, British Patent No. 927,446, or JP-A Nos. 55-126238 and 58-90633, higher fatty acid metal salts disclosed in U.S. Pat. No. 3,933,516, polyester compounds composed of dicarboxylic acid having at least 10 carbon atoms and aliphatic or alicyclic diol disclosed in JP-A No. 51-37217, and oligopolyesters composed of dicarboxylic acid and diol disclosed in JP-A No. 7-13292.

Silicon oils disclosed in Table 1 of Japanese Patent O.P.I. Publication Nos. 2005-156801 are especially preferably used.

For example, the added amount of slipping agents employed in the low refractive index layer is preferably 0.01 to 10 mg/m².

In the invention, a high refractive index layer is preferably provided between a transparent substrate provided with a UV cured resin layer and a low refractive index layer in order to reduce reflectance. It is more preferred that a medium refractive index layer is provided between the transparent substrate and the high refractive index layer in order to reduce reflectance. The refractive index of the high refractive index layer is preferably from 1.55 to 2.30, and more preferably from 1.57 to 2.20. The refractive index of the medium refractive index layer is adjusted so as to be between a refractive index of the transparent substrate and that of the high refractive index layer. The refractive index of the medium refractive index layer is preferably from 1.55 to 1.80. The thickness of the high or medium refractive index layer is preferably from 5 nm to 1 μm, more preferably from 10 nm to 0.2 μm, and most preferably from 30 nm to 0.1 μm. The haze of the high or medium refractive index layer is preferably 5% or less, more preferably 3% or less, and most preferably from 1% or less. The strength of the high or medium refractive index layer is preferably 1H or more, more preferably 2H or more, and most preferably 3H or more in terms of pencil hardness being measured with 1 kg load.

It is preferred that the medium and high refractive index layers in the present invention are formed in such a manner that a coating solution containing monomers or oligomers of organic titanium compounds represented by the following Formula or hydrolyzed products thereof is coated and subsequently dried to form a layer having a refractive index of from 1.55 to 2.5.

Ti(OR¹)₄ Formula

wherein R¹ is an aliphatic hydrocarbon group having 1 to 8 carbon atoms, but is preferably an aliphatic hydrocarbon group having 1-4 carbon atoms. Further, in monomers or oligomers of organic titanium compounds or hydrolyzed products thereof, the alkoxide group undergoes hydrolysis to form a crosslinking structure via reaction such as —Ti—O—Ti—, whereby a cured layer is formed.

Listed as preferred examples of monomers and oligomers of organic titanium compounds employed in the invention are a dimer to a decamer of Ti(OCH₃)₄, Ti(OC₂H₅)₄, Ti(O-n-C₃H₇)₄, Ti(O-i-C₃H₇)₄, Ti(O-n-C₄H₉)₄, a dimer to a decamer of Ti(O-n-C₃H₇)₄, a dimer to a decamer of Ti(O-i-C₃H₇)₄, and a dimer to a decamer of Ti(O-n-C₄H₉)₄. These may be employed individually or in combinations of at least two types. Of these, particularly preferred are Ti(O-n-C₃H₇)₄, Ti(O-i-C₃H₇)₄, Ti(O-n-C₄H₉)₄, a dimer to a decamer of Ti(O-n-C₃H₇)₄ and a dimer to a decamer of Ti(O-n-C₄H₉)₄.

In the course of preparation of the high refractive index layer coating solution in the invention, it is preferred that the above organic titanium compounds are added to the solution into which water and organic solvents, described below, have been successively added. When water is added later, hydrolysis/polymerization is not uniformly performed, whereby cloudiness is generated or the layer strength is lowered. It is preferred that after adding water and organic solvents, the resulting mixture is vigorously stirred to enhance mixing, whereby dissolution has been completed.

Further, an alternative method is employed. A preferred embodiment is that organic titanium compounds and organic solvents are blended, and the resulting mixed solution is added to the above solution which is prepared by stirring the mixture of water and organic solvents.

Further, the amount of water is preferably in the range of 0.25 to 3 mol per mol of the organic titanium compounds. When the amount of water is less than 0.25 mol, hydrolysis and polymerization are not sufficiently performed, whereby layer strength is lowered, while when it exceeds 3 mol, hydrolysis and polymerization are excessively performed, and coarse TiO₂ particles are formed to result in cloudiness. Accordingly, it is necessary to control the amount of water within the above range.

Further, the content of water is preferably less than 10 percent by weight with respect to the total liquid coating composition. When the content of water exceeds 10 percent by weight with respect to the total liquid coating composition, stability during standing of the liquid coating composition is degraded to result in cloudiness. Therefore, it is not preferable.

Organic solvents employed in the present invention are preferably water-compatible. Preferred as water-compatible solvents are, for example, alcohols (for example, methanol, ethanol, propanol, isopropanol, butanol, isobutanol, secondary butanol, tertiary butanol, pentanol, hexanol, cyclohexanol, and benzyl alcohol; polyhydric alcohols (for example, ethylene glycol, diethylene glycol, triethylene glycol, polyethylene glycol, propylene glycol, dipropylene glycol, polypropylene glycol, butylenes glycol, hexanediol, pentanediol, glycerin, hexanetriol, and thioglycol); polyhydric alcohol ethers (for example, ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, propylene glycol monomethyl ether, propylene glycol monobutyl ether, ethylene glycol monomethyl ether acetate, triethylene glycol monomethyl ether, triethylene glycol monoethyl ether, ethylene glycol monophenyl ether, and propylene glycol monophenyl ether); amines (for example, ethanolamine, diethanolamine, triethanolamine, N-methyldiethanolamine, N-ethyldiethanolamine, morpholine, N-ethylmorpholine, ethylenediamine, diethylenediamine, triethylenetetramine, tetraethylenepentamine, polyethyleneimine, pentamthyldiethylenetriamine, and tetramethylpropylenediamine); amides (for example, formamide, N,N-dimethylfromamide, and N,N-dimethylacetamide); heterocycles (for example, 2-pyrrolidone, N-methyl-2-pyrrolidone, cyclohexylpyrrolidone, 2-oxazolidone, 1,3-dimethyl-2-imidazolidinone); and sulfoxides (for example, dimethylsulfoxide); sulfones (for example, sulfolane); as well as urea, acetonitrile, and acetone. Of these, particularly preferred are alcohols, polyhydric alcohols, and polyhydric alcohol ethers.

As noted above, the used amount of these organic solvents may be controlled so that the content of water is less than 10 percent by weight with respect to the total coating solution, controlling the total used amount of water and the organic solvents.

The content of monomers and oligomers of organic titanium compounds employed in the invention, as well as hydrolyzed products thereof is preferably 50.0 to 98.0 percent by weight with respect to solids incorporated in the coating solution. The solid ratio is more preferably 50 to 90 percent by weight, but is still more preferably 55 to 90 percent by weight. Other than these, it is preferable to incorporate polymers of organic titanium compounds (which are subjected to hydrolysis followed by crosslinking) in the coating solution, or to incorporate minute titanium oxide particles.

In order to improve physical properties of the high or medium refractive index layer, a coating composition therefor preferably contains a metal compound.

Examples of the metal compound include a zirconium compound such as such as zirconium tri-n-butoxyethylacetoacetate, zirconium di-n-butoxybis(ethylacetoacetate), zirconium n-butoxytris(ethylacetoacetate), zirconium tetrakis-(n-propylacetoacetate), zirconium tetrakis-(acetylacetoacetate) or zirconium tetrakis(ethyl acetoacetate); a titanium compound such as titanium diisopropoxybis-(ethylacetoacetate), titanium diisopropoxy-bis(acetylacetate) or titanium diisopropoxy-bis(acetylacetone); and an aluminum compound such as aluminum diisopropoxyethylacetoacetate, aluminum diisopropoxyacetylacetonate, aluminum isopropoxy-bis(ethylacetoacetate), aluminum isopropoxy-bis(acetylacetonate), aluminum tris(ethylacetoacetate), aluminum tris(ethylacetonate), aluminum tris(acetylacetonate) and aluminum monoacetylacetonatobis(ethylacetoacetate).

Among these metal compounds, zirconium tri-n-butoxyethylacetoacetate, titanium diisopropoxy-bis(acetylacetate), aluminum diisopropoxyethylacetoacetate and aluminum tris(ethylacetoacetate) are preferred.

These metal compounds may be used singly or as a mixture of two or more kinds thereof. The partially hydrolyzed product of these metal compounds can be used. The metal compound content of the coating composition is preferably from 0.01 to 50 by weight, and more preferably from 0.1 to 50% by weight, and still more preferably from 0.5 to 10% by weight, based on the solid content of each layer.

It is preferred that the high refractive index and medium refractive index layers in the invention contain metal oxide particles as microparticles and further contain binder polymers.

In the above method of preparing the coating solution when hydrolyzed/polymerized organic titanium compounds and metal oxide particles are combined, both strongly adhere to each other, whereby it is possible to obtain a strong coating layer provided with hardness and uniform layer flexibility.

The refractive index of metal oxide particles employed in the high and medium refractive index layers is preferably 1.80 to 2.80, but is more preferably 1.90 to 2.80. The weight average diameter of the primary particle of metal oxide particles is preferably 1 to 150 nm, is more preferably 1 to 100 nm, and is most preferably 1 to 80 nm. The weight average diameter of metal oxide particles in the layer is preferably 1 to 200 nm, is more preferably 5 to 150 nm, is still more preferably 10 to 100 nm, and is most preferably 10 to 80 nm. Metal oxide particles at an average particle diameter of at least 20 to 30 nm are determined employing a light scattering method, while the particles at a diameter of at most 20 to 30 nm are determined employing electron microscope images. The specific surface area of metal oxide particles is preferably 10 to 400 m²/g as a value determined employing the BET method, is more preferably 20 to 200 m²/g, and is most preferably 30 to 150 m²/g.

Examples of metal oxide particles are metal oxides incorporating at least one element selected from the group consisting of Ti, Zr, Sn, Sb, Cu, Fe, Mn, Pb, Cd, As, Cr, Hg, Zn, Al, Mg, Si, P, and S. Specifically listed are titanium dioxide, (for example, rutile, rutile/anatase mixed crystals, anatase, and amorphous structures), tin oxide, indium oxide, zinc oxide, and zirconium oxide. Of these, titanium oxide, tin oxide, and indium oxide are particularly preferred. Metal oxide particles are composed of these metals as a main component of oxides and are capable of incorporating other metals. Main component, as described herein, refers to the component of which content (in percent by weight) is the maximum in the particle composing components. Listed as examples of other elements are Ti, Zr, Sn, Sb, Cu, Fe, Mn, Pb, Cd, As, Cr, Hg, Zn, Al, Mg, Si, P and S.

It is preferred that metal oxide particles are subjected to a surface treatment. It is possible to perform the surface treatment employing inorganic or organic compounds. Listed as examples of inorganic compounds used for the surface treatment are alumina, silica, zirconium oxide, and iron oxide. Of these, alumina and silica are preferred. Listed as examples of organic compounds used for the surface treatment are polyol, alkanolamine, stearic acid, silane coupling agents, and titanate coupling agents. Of these, silane coupling agents are most preferred.

Specific examples of silane coupling agents include methyltrimethoxysilane, methyltriethoxysilane, methyltrimethoxyethoxysilane, methyltriacetoxysilane, methyltributoxysilane, ethyltrimethoxysilane, ethyltriethoxysilane, vinyltrimethoxysilane, vinyltriethoxysilane, vinyltriacetoxysilane, vinyltrimethoxyethoxysilane, phenyltrimethoxysilane, phenyltriethoxysilane, phenyltriacetoxysilane, γ-chloropropyltrimethoxysilane, γ-chloropropyltriethoxysilane, γ-chloropropyltriacetoxysilane, 3,3,3-trifluoropropyltrimethoxysilane, γ-glycidyloxypropyl-trimethoxysilane, γ-glycidyloxypropyltriethoxysilane, γ-(β-glycidyloxyethoxy)propyltrimethoxysilane, β-(3,4-epoxycyclohexyl)ethyltrimethoxysilane, β-(3,4-epoxycyclohexyl)ethyltriethoxysilane, γ-acryloyloxypropyl-trimethoxysilane, γ-methacryloyloxypropyl-trimethoxysilane, γ-aminopropyltrimethoxysilane, γ-aminopropyltriethoxysilane, γ-mercaptopropyltriethoxysilane, N-β-(aminoethyl)-γ-aminopropyltrimethoxysilane, and β-cyanoethyltriethoxysilane.

Further, examples of silane coupling agents having an alkyl group of 2-substitution for silicon include dimethyldimethoxysilane, phenylmethyldimethoxysilane, dimethyldiethoxysilane, phenylmethyldiethoxysilane, γ-glycidyloxypropylmethyldiethoxysilane, γ-glycidyloxypropylmethyldimethoxysilane, γ-glycidyloxypropylphenyldiethoxysilane, γ-chloropropylmethyldiethoxysilane, dimethyldiacetoxysilane, γ-acryloyloxypropylmethyldimethoxysilane, γ-acryloyloxypropyl-methyldiethoxysilane, γ-methacryloyloxypropylmethyl-dimethoxysilane, γ-methacryloyloxypropylmethyldlethoxysilane, γ-mercaptopropylmethyldimethoxysilane, γ-mercaptopropyl-methyldiethoxysilane, γ-aminopropylmethyldimethoxysilane, γ-aminopropyldiethoxysilane, methylvinyldimethoxysilane, and methylvinyldiethoxysilnae.

Of these, preferred are vinyltrimethoxysilane, vinyltriethoxysilane, vinylacetoxysilane, vinyltrimethoxethoxyysilane, γ-acryloyloxypropyl-methoxysilane, and γ-methacryloyloxypropylmethoxysilane, each having a double bond in the molecule, as well as γ-acryloyloxypropylmethyldimethoxy-silane, γ-acryloyloxpropyldiethoxysilane, γ-methacryloyloxypropyl-methyldimethoxysilane, γ-methacryloyloxypropylmethyl-diethjoxysilane, methylvinyldimethoxysilane, and methylvinyldiethaoxysilane, each having an alkyl group having 2-substitution to silicon. Of these, particularly preferred are γ-acryloyloxypropyltrimethoxysilane, γ-methacryloyloxy-propyltrimethoxysilane, γ-acryloyloxypropylmethyl-dimethoxysilane, γ-acryloyloxypropylmethyldiethoxysilane, γ-methacryloyloxypropylmethyldimethoxysilane, and γ-methacryloyloxypropylmethyldiethoxysilane.

At least two types of coupling agents may simultaneously be employed. In addition to the above silane coupling agents, other silane coupling agents may be employed. Listed as other silane coupling agents are alkyl esters of ortho-silicic acid (for example, methyl orthosilicate, ethyl orthosilicate, n-propyl orthosilicate, i-propyl orthosilicate, n-butyl orthosilicate, sec-butyl orthosilicate, and t-butyl orthosilicate) and hydrolyzed products thereof.

It is possible to practice a surface treatment employing coupling agents in such a manner that coupling agents are added to a minute particle dispersion and the resulting dispersion is allowed to stand at room temperature to 60° C. for several hours to 10 days. In order to promote the surface treatment reaction, added to the above dispersion may be inorganic acids (for example, sulfuric acid, hydrochloric acid, nitric acid, chromic acid, hypochlorous acid, boric acid, orthosilicic acid, phosphoric acid, and carbonic acid), and organic acids (for example, acetic acid, polyacrylic acid, benzenesulfonic acid, phenol, and polyglutamic acid), or salts thereof (for example, metal salts and ammonium salts).

It is preferred that these coupling agents have been hydrolyzed employing water in a necessary amount. When the silane coupling agent is hydrolyzed, the resulting coupling agent easily react with the above organic titanium compounds and the surface of metal oxide particles, whereby a stronger layer is formed. Further, it is preferred to previously incorporate hydrolyzed silane coupling agents into a liquid coating composition. It is possible to use the water employed for hydrolysis to perform hydrolysis/polymerization of organic titanium compounds.

A combination of combining at least two types of surface treatments may be performed. It is preferred that the shape of metal oxide particles is rice grain-shaped, spherical, cubic, spindle-shaped, or irregular. At least two types of metal oxide particles may be employed in the high refractive index layer and the medium refractive index layer.

The content of metal oxide particles in the high refractive index and medium refractive index layers is preferably 5 to 65 percent by volume, is more preferably 10 to 60 percent by volume, and is still more preferably 20 to 55 percent by volume.

The above metal oxide particles are dispersed into a medium and used as a coating solution for forming a high refractive index layer and a medium refractive index layer. Preferably employed as dispersion medium of metal oxide particles is liquid with a boiling point of 60 to 170° C. Specific examples of dispersion media include water, alcohols (for example, methanol, ethanol, isopropanol, butanol, and benzyl alcohol), ketones (for example, acetone, methyl ethyl ketone, methyl isobutyl ketone, and cyclohexanone), esters (for example, methyl acetate, ethyl acetate, propyl acetate, butyl acetate, methyl formate, ethyl formate, propyl formate and butyl formate), aliphatic hydrocarbons (for example, hexane and cyclohexanone), halogenated hydrocarbons (for example, methylene chloride, chloroform, and carbon tetrachloride), aromatic hydrocarbons (for example, benzene, toluene, and xylene), amides (for example, dimethylforimamide, diethylacetamide, and n-methylpyrrolidone), ethers (for example, diethyl ether, dioxane, and tetrahydrofuran), and ether alcohols (for example, 1-methoxy-2-propanol). Of these, particularly preferred are toluene, xylene, methyl ethyl ketone, methyl isobutyl ketone, cyclohexane and butanol.

Further, it is possible to disperse metal oxide particles into a medium employing a homogenizer. Listed as examples of homogenizers are a sand grinder mill (for example, a bead mill with pins), a high speed impeller mill, a pebble mill, a roller mill, an attritor, and a colloid mill. Of these, particularly preferred are the sand grinder and the high speed impeller mill. Preliminary dispersion may be performed. Listed as examples of a homogenizer to be used for the preliminary dispersion are a ball mill, a three-roller mill, a kneader, and an extruder.

It is preferred to employ polymers having a crosslinked structure (hereinafter referred to as a crosslinked polymer) as a binder polymer in the high refractive index and medium refractive index layers. Listed as examples of the crosslinked polymers are crosslinked products of polymers having a saturated hydrocarbon chain such as polyolefin (hereinafter referred to as polyolefin), polyether, polyurea, polyurethane, polyester, polyamine, polyamide or melamine resins. Of these, crosslinked products of polyolefin, polyether or polyurethane are preferred, crosslinked products of polyolefin or polyether are more preferred, and crosslinked products of polyolefin are most preferred. Further, it is more preferable that crosslinked polymers have an anionic group. The anionic group exhibits a function to maintain the dispersion state of minute inorganic particles and the crosslinked structure exhibits a function to strengthen layers by providing a polymer with layer forming capability. The above anionic group may directly bond to a polymer chain or may bond to a polymer chain via a linking group. However, it is preferred that the anionic group bonds to the main chain via a linking group as a side chain.

Listed as examples of the anionic group are a carboxylic acid group (carboxyl), a sulfonic acid group (sulfa), and phosphoric acid group (phsphono). Of these, preferred are the sulfonic acid group and the phosphoric acid group. Herein, the anionic group may be in the form of its salts. Cations which form salts with the anionic group are preferably alkali metal ions. Further, protons of the anionic group may be dissociated. The linking group which bond the anionic group with a polymer chain is preferably a bivalent group selected from the group consisting of —CO—, —O—, an alkylene group, and an arylene group, and combinations thereof. Crosslinking polymers which are binder polymers are preferably copolymers having repeating units having an anionic group and repeating units having a crosslinking structure. In this case, the ratio of the repeating units having an anionic group in copolymers is preferably 2-96 percent by weight, is more preferably 4-94 percent by weight, but is most preferably 6-92 percent by weight. The repeating unit may have at least two anionic groups.

In crosslinked polymers having an anionic group, other repeating units (an anionic group is also a repeating unit having no crosslinked structure) may be incorporated. Preferred as other repeating units are repeating units having an amino group or a quaternary ammonium group and repeating units having a benzene ring. The amino group or quaternary ammonium group exhibits a function to maintain a dispersion state of minute inorganic particles. The benzene ring exhibits a function to increase the refractive index of the high refractive index layer. Incidentally, even though the amino group, quaternary ammonium group and benzene ring are incorporated in the repeating units having an anionic group and the repeating units having a crosslinked structure, identical effects are achieved.

In crosslinked polymers incorporating as a constituting unit the above repeating units having an amino group or a quaternary ammonium group, the amino group or quaternary ammonium group may directly bond to a polymer chain or may bond to a polymer chain via a side chain. But the latter is preferred. The amino group or quaternary ammonium group is preferably a secondary amino group, a tertiary amino group or a quaternary ammonium group, but is more preferably a tertiary amino group or a quaternary ammonium group. A group bonded to the nitrogen atom of a secondary amino group, a tertiary amino group or a quaternary ammonium group is preferably an alkyl group, is more preferably an alkyl group having 1 to 12 carbon atoms, but is still more preferably an alkyl group having 1 to 6 carbon atoms. The counter ion of the quaternary ammonium group is preferably a halide ion. The linking group which links an amino group or a quaternary ammonium group with a polymer chain is preferably a bivalent group selected from the group consisting of —CO—, —NH—, —O—, an alkylene group and an arylene group, or combinations thereof.

When the crosslinked polymers contain repeating units having an amino group or an quaternary ammonium group, the ratio is preferably 0.06 to 32 percent by weight, is more preferably 0.08 to 30 percent by weight, and is most preferably 0.1 to 28 percent t by weight.

It is preferred that high and medium refractive index layer coating solution containing monomers to form crosslinking polymers are prepared and crosslinked polymers are formed via polymerization reaction during or after coating of the coating solution. Each layer is formed along with the formation of crosslinked polymers. Monomers having an anionic group function as a dispersing agent of minute inorganic particles in the liquid coating compositions. The used amount of monomers having an anionic group is preferably 1 to 50 percent by weight with respect to the minute inorganic particles, is more preferably 5 to 40 percent by weight, and is still more preferably 10 to 30 percent by weight. Further, monomers having an amino group or a quaternary ammonium group function as a dispersing aid in the coating solution. The used amount of monomers having an amino group or a quaternary ammonium group is preferably 3 to 33 percent by weight with respect to the monomers having an anionic group. By employing a method in which crosslinked polymers are formed during or after coating of coating solution, it is possible to allow these monomers to effectively function prior to coating of the coating solution.

Most preferred as monomers employed in the invention are those having at least two ethylenic unsaturated groups. Listed as those examples are esters of polyhydric alcohols and (meth)acrylic acid (for example, ethylene glycol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol (meth)acrylate, pentaerythritol hexa(meth)acrylate, 1,2,3-cyclohexane tetramethacrylate, polyurethane polyacrylate, and polyester polyacrylate); vinylbenzene and derivatives thereof (for example, 1,4-divinylbenzene, 4-vinyl-benzoic acid-2-acryloylethyl ester, and 1,4-divinylcyclohexane); vinylsulfones (for example, divinylsulfone); acrylamides (for example, methylenebisacrylamide); and methacrylamides.

Commercially available monomers having an anionic group and monomers having an amino group or a quaternary ammonium group may be employed. Listed as commercially available monomers having an anionic group which are preferably employed are KAYAMAR PM-21 and PM-2 (both produced by Nihon Kayaku Co., Ltd.); ANTOX MS-60, MS-2N, and MS-NH4 (all produced by Nippon Nyukazai Co., Ltd.), ARONIX M-5000, M-6000, and M-8000 SERIES (all produced by Toagosei Chemical Industry Co., Ltd.); BISCOAT #2000 SERIES (produced by Osaka Organic Chemical Industry Ltd.); NEW FRONTIER GX-8289 (produced by Dai-ichi Kogyo Seiyaku Co., Ltd.); NK ESTER CB-1 and A-SA (produced by Shin-Nakamura Chemical Co., Ltd.); and AR-100, MR-100, and MR-200 (produced by Diahachi Chemical Industry Co., Ltd.). Listed as commercially available monomers having an amino group or a quaternary ammonium group which are preferably employed are DMAA (produced by Osaka Organic Chemical Industry Ltd.); DMAEA and DMAPAA (produced by Kojin Co., Ltd.); BLENMER QA (produced by NOF Corp.), and NEW FRONTIER C-1615 (produced by Dia-ichi Kogyo Seiyaku Co., Ltd.).

It is possible to perform polymer polymerization reaction employing a photopolymerization reaction or a thermal polymerization reaction. The photopolymerization reaction is particularly preferred. It is preferred to employ polymerization initiators to perform the polymerization reaction. For example, listed are thermal polymerization initiators and photopolymerization imitators described below which are employed to form binder polymers of a UV curable resin layer.

Employed as the polymerization initiators may be commercially available ones. In addition to the polymerization initiators, employed may be polymerization promoters. The added amount of polymerization initiators and polymerization promoters is preferably in the range of 0.2 to 10 percent by weight of the total monomers. Polymerization of monomers (or oligomers) may be promoted by heating a coating solution (being an inorganic particle dispersion containing monomers). Further, after the photopolymerization reaction after coating, the resulting coating is heated whereby the formed polymer may undergo additional heat curing reaction.

It is preferable to use relatively high refractive index polymers in the medium and high refractive index layers. Listed as examples of polymers exhibiting a high refractive index are polystyrene, styrene copolymers, polycarbonates, melamine resins, phenol resins, epoxy resins, and urethanes which are obtained by allowing cyclic (alicyclic or aromatic) isocyanates to react with polyols. It is also possible to use polymers having another cyclic (aromatic, heterocyclic, and alicyclic) group and polymers having a halogen atom other than fluorine as a substituent due to their high refractive index.

It is possible to form each layer of the antireflection layer employing coating methods such as a dip coating method, an air-knife coating method, a curtain coating method, a roller coating method, a wire bar coating method, a gravure coating method, a micro-gravure coating method, an extrusion coating method, a spray coating method or an ink-jetting method.

### <Back Coat Layer>

In the invention, a back coat layer is preferably provided on the surface of a substrate opposite the UV curable resin layer having a concavo-convex surface. The back coat layer is provided for preventing curling caused by forming a concave-convex structure, the UV curable resin layer or other layers. That is, by adding a counter force to curl toward the back coat side, the forces to curl may be balanced out. Also, a back coat layer preferably has a feature to prevent blocking. For this purpose, particles are preferably added to a coating solution of back coat layer.

Examples of inorganic particles preferably added to the back coat layer include: silicon dioxide, titanium dioxide, aluminum oxide, zirconium oxide, calcium carbonate, talc, clay, calcined kaolin, calcined calcium silicate, tin oxide, indium oxide, zinc oxide, ITO, hydrated calcium silicate, aluminum silicate, magnesium silicate and calcium phosphate. Particles containing silicon are preferably used to minimize the haze. Of these, silicon dioxide is specifically preferable.

Inorganic particle available on the market include, for example: AEROSIL R972, R972V, R9741, R812, 200, 200V, 300, 5202, OX50 and TT600, which are manufactured by Nippon Aerosil Co. Ltd. Particles of zirconium oxide available on the market include, for example: AEROSIL R976 and R811 manufactured by Nippon Aerosil Co. Ltd. Particles of polymer include, for example: silicone resin, fluorine-contained resin and acryl resin. Among these, silicone resin, especially three dimensionally networked silicone resin is preferably used. Examples of silicone resins available on the market include TOSPERL 103, 105, 108, 120, 145, 3120 and 240, which are manufactured by Toshiba Silicone Co., Ltd.

Among the particles listed above, AEROSIL 200V and AEROSIL R972V are specifically preferable with respect to effectively preventing blocking while minimizing haze. The kinetic friction coefficient of the rear side of the hard coat layer in the present invention is preferably not more than 0.9 and specifically preferably from 0.1 to 0.9.

The content of particles contained in the back coat layer is preferably 0.1 to 50% by weight and more preferably 0.1 to 10% by weight. The increase in haze after the hard coat film is provided with a back coat layer is preferably not more than 1%, more preferably not more than 0.5% and specifically preferably 0.0 to 0.1%.

Specifically, a function of the back coat layer may be provided by applying a coating composition containing a solvent which dissolves or swells cellulose ester. The coating composition may occasionally contain a solvent which does not dissolve cellulose ester, in addition to a mixture of the solvents which dissolves and/or swells cellulose ester. The mixing ratio of these solvents and the amount of the coating solution to be used for forming a back coat layer is appropriately determined depending on the extent of the curl and the type of the resin used for a transparent resin film.

In order to have an enhanced effect to preventing curl in the film, the mixing ratio of the solvent which dissolves and/or swells cellulose ester is increased while the ratio of the solvent which does not dissolve nor swell cellulose ester is decreased. The mixing ratio of (the solvent which dissolves and/or swells cellulose ester) to (the solvent which does not dissolve cellulose ester) is preferably 10:0-1:9. Examples of the solvent which dissolves and/or swells transparent resin film include dioxane, acetone, methyl ethyl ketone, N,N-dimethyl formamide, methyl acetate, ethyl acetate, trichloroethylene, methylene chloride, ethylene chloride, tetrachloroethane, trichloroethane and chloroform Examples of the solvent which does not dissolve transparent resin film include methanol, ethanol, n-propyl alcohol, i-propyl alcohol, n-butanol, cyclohexanol, and hydrocarbons such as toluene and xylene.

The back coat layer is coated by means of, for example: a gravure coater, a dip coater, a reverse coater, a wire-bar coater, a die coater, a spray coater and ink-jet printing, in a thickness of preferably from 1 to 100 μm and specifically preferably from 5 to 30 μm. Resins utilized as a binder in a back coat layer include, for example: (i) vinyl type homopolymers or copolymers such as a vinyl chloride/vinyl acetate copolymer, a vinyl chloride resin, a vinyl acetate resin, a copolymer of vinyl acetate and vinyl alcohol, a partially hydrolyzed vinyl chloride/vinyl acetate copolymer, a vinyl chloride/vinylidene chloride copolymer, a vinyl chloride/acrylonitrile copolymer, an ethylene/vinyl alcohol copolymer, a chlorinated polyvinylchloride, an ethylene/vinyl chloride copolymer and a ethylene/vinyl acetate copolymer; (ii) cellulose derivatives such as cellulose nitrate, cellulose acetate propionate (acetyl substitution degree is preferably 1.8 to 2.3, and propionyl substitution degree is preferably 0.1 to 1.0), cellulose diacetate, cellulose triacetate and cellulose acetate butylate; (iii) rubber type resins such as a copolymer of maleic acid and/or acrylic acid, a copolymer of acrylate ester, an acrylonitrile/stylene copolymer, a chlorinated polyethylene, an acrylonitrile/chlorinated polyethylene/stylene copolymer, a methyl methacrylate/butadiene/stylene copolymer, an acryl resin, a polyvinylacetal resin, a polyvinylbutyral resin, a polyester polyurethane resin, a polyether polyurethane resin, a polycarbonate polyurethane resin, a polyester resin, a polyether resin, a polyamide resin, an amino resin, a stylene/butadiene resin and a butadiene/acrilonitrile resin; (iv) a silicone type resin; and (v) a fluorine-containing type resin, (vi) polymethyl methacrylate, and (vii) a copolymer of polymethyl methacrylate and polymethyl acrylate, however, the present invention is not limited thereto. Examples of acryl resins available on the market include homopolymers and copolymers produced from acryl or methacryl monomers, such as: Acrypet MD, VH, MF and V (manufactured by Mitsubishi Rayon Co., Ltd.), Hi Pearl M-4003, M-4005, M-4006, M-4202, M-5000, M-5001 and M-4501 (Negami Chemical Industrial Co., Ltd.), Dianal BR-50, BR-52, BR-53, BR-60, BR-64, BR-73, BR-75, BR-77, BR-79, BR-80, BR-82, BR-83, BR-85, BR-87, BR-88, BR-90, BR-93, BR-95, BR-100, BR-101, BR-102, BR-105, BR-106, BR-107, BR-108, BR-112, BR-113, BR-115, BR-116, BR-117 and BR-118 (manufactured by Mitsubishi Rayon Co., Ltd). A resin used in the present invention may suitably be selected from the above examples.

Cellulose resins such as diacetyl cellulose and cellulose acetate propionate are specifically preferable.

The coating order of a back coat layer on a cellulose ester film is not specifically limited, namely, a back coat layer may be formed before or after forming the UV curable resin layer having a concavo-convex surface, however, the back coat layer is preferably formed after forming the UV curable resin layer having a concavo-convex surface.

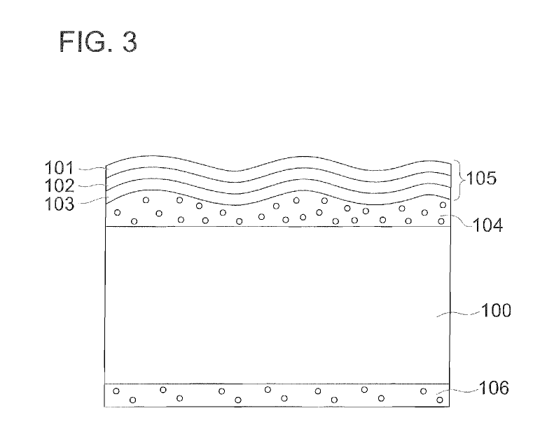

FIG. 3 is an illustration showing a section of the antiglaring antireflection film in the invention.

A UV cured resin layer 104 with a concavo-convex pattern prepared according to the process of the invention and an antireflection layer 105 are provided in that order on the transparent resin film 100. The numerical number 106 shows a back coat layer. Particularly, the microparticles contained in the UV cured resin layer 104 with a concavo-convex pattern can provide inner light-scattering effect and excellent antiglaring effect.

### EXAMPLES

Next, the present invention will be explained employing examples, but the invention is not limited thereto.

### Example 1

### Embossing of Quartz Glass Roll

The surface of a quartz glass roll (with a length of 1600 mm and a diameter of 300 mm) was subjected to sand blasting treatment employing monodisperse alumina crystal particles “Sumikorandom AA-5” (with an average particle size of 5 μm) produced by Sumitomo Chemical Co., Ltd., while rotating the roll and moving the roll sidewise. Herein, the blasting pressure was 50 kPa, and the blasting time was 120 seconds. The resulting quartz glass roll was subjected to ultrasonic cleaning, dried, immersed in a 1% by weight hydrogen fluoride solution at 40° C. for 10 minutes, washed with pure water, and dried to obtain an embossing quartz roll. The arithmetic average surface roughness Ra of the embossing quartz roll was 0.3 μm, and the average periodic distance of the concavo-convex pattern formed on the embossing quartz roll was 25 μm.

### Embossing Quartz Roll Coated with Photocatalyst Layer

The embossing quartz roll was placed in a plasma discharge processing apparatus (hereinafter also referred to as an atmospheric pressure plasma discharge processing apparatus), and subjected to plasma processing under the following discharge condition, employing the following reaction gas. Thus, an embossing quartz roll coated with a titanium oxide photocatalyst layer was prepared.

As a power sources for generating plasma is preferably used a high frequency power source (50 kHz) produced by Shinko Denki Co., Ltd., an impulse high frequency power source (continuous mode, 100 kHz) produced by Haiden Kenkyusho, a high frequency power source (200 kHz) produced by Pearl Kogyo Co., Ltd, a high frequency power source (800 kHz) produced by Pearl Kogyo Co., Ltd., a high frequency power source (13.56 MHz) produced by Nippon Denshi Co. Ltd., or a high frequency power source (150 MHz) produced by Pearl Kogyo Co., Ltd.

### (Discharge Condition)

The discharge output was 4 W/cm².

### (Reaction Gas)

| | | |
|---|---|---|
| Inert gas: an argon gas | 98.75% | by volume |
| Reactive gas 1: a hydrogen gas | 1% | by volume |
| Reactive gas 2: tetraisopropoxytitanium vapor | 0.25% | by volume |
| (gasified by bubbling liquid heated to 150° C. | | |
| with an argon gas) | | |

The embossing quartz roll was subjected to continuous plasma processing under the above conditions to prepare an embossing roll coated with a 0.1 μm thick titanium oxide photocatalyst layer.

### UV Curable Resin Composition

| | | |
|---|---|---|
| Dipentaerythritol hexacrylate | 70 | parts by weight |
| Trimethylolpropane triacrylate | 30 | parts by weight |
| Photointiator (IRGACURE 184 produced by | 4 | parts by weight |
| Ciba Specialty Chemicals Co., Ltd.) | | |
| Ethyl acetate | 150 | parts by weight |
| Propylene glycol monomethylether | 150 | parts by weight |
| Silicon-containing compound (BYK-307 | 0.4 | parts by weight |
| produced by BYK Chemie, Japan Co., Ltd.) | | |
| Microparticles (Silicon oxide | 5 | parts by weight |
| microparticles with an average primary | | |
| particle size of 16 nm) | | |

The microparticles were dispersed in a part of the solvents used, and added to the composition.

The above composition was coated on one surface of a 80 μm thick triacetyl cellulose film produced by Konica Minolta Opt Co., Ltd. at dark room employing a die coater to form a UV cured resin layer. The resulting film was dried in an oven at 80° C. for five minutes. Subsequently, the film was passed between the guide rolls 6 and the embossing quartz roll coated with the photocatalyst layer, as shown in FIG. 2. Herein, the formed UV curable resin layer, while the triacetyl cellulose ester film was passed between the two guide rolls 6, was exposed to ultraviolet ray and cured, employing a UV irradiation device (a high pressure mercury lamp) 10 provided inside the embossing quartz roll as shown in FIG. 2. The exposure amount of the ultraviolet ray was 0.5 J/cm².

Subsequently, the triacetyl cellulose ester film with a UV cured resin layer was peeled from the embossing quartz roll. The concavo-convex pattern formed on the UV cured resin layer surface had no defects, and after the peeling, no residual cured resin was observed on the concavo-convex pattern surface of the embossing roll with the photocatalyst layer.

### Comparative Example

The embossing glass roll (with a length of 1600 mm and a diameter of 300 mm) having the same arithmetic average surface roughness (Ra) and average periodic distance of the concavo-convex pattern as the embossing quartz roll as above was prepared, except that a glass roll comprised of soda lime glass produced by Nippon Sheet Glass Company, Limited was used instead of the quartz glass roll. The concavo-convex pattern was formed on the UV cured resin layer surface of the triacetyl cellulose ester film in the same manner as above, except that the photocatalyst layer was not coated on the embossing glass roll.

It proved that during continuous film production, occurrence frequency of residual cured resin, remaining on the concavo-convex pattern surface of the embossing roll not coated with a photocatalyst layer, increased, resulting in increase of cleaning frequency and in lowering of productivity.

### Example 2

### Preparation of Inorganic Binder Solution

A mixture of 250 g of tetraethoxysilane, 400 g of ethanol, 50 g of water, and 0.8 g of 60% nitric acid solution was heated at 45° C. for 2.5 hours to prepare an inorganic binder solution containing a partially hydrolyzed tetraethoxysilane.

### Preparation of Titanium Oxide Dispersion Solution

A mixture of 10 g of an anatase type microparticle dispersion solution made by a gas phase method (P-25 with a primary average particle size of 0.02 μm, produced by Nippon Aerosil Co., Ltd.) and 40 g of ethanol was dispersed in a paint shaker for 16 hours in the presence of 100 g of zirconia beads to prepare a titanium oxide dispersion solution.

### Preparation of Photocatalyst Layer Coating Solution

The above-obtained inorganic binder solution was mixed with the above-obtained titanium oxide dispersion solution so that ratio TiO₂/SiO₂ was 70/30. Thus, a photocatalyst layer coating solution was prepared. With respect to the amount of SiO₂, the partially hydrolyzed tetraethoxysilane in the inorganic binder solution is calculated in terms of SiO₂.

### Coating

The photocatalyst layer coating solution was coated through a spin coater on the embossing quartz glass roll prepared in the same manner as in Example 1, and dried at 150° C. for one hour to prepare an embossing quartz roll coated with a photocatalyst layer with an average thickness of 0.2 μm. The arithmetic average surface roughness Ra of the embossing quartz roll was 0.1 μm, and the average periodic distance of the concavo-convex pattern formed on the embossing quartz roll was 50 μm.

### Preparation of Film Having Concavo-Convex Pattern

A film having a concavo-convex pattern on the surface was prepared in the same manner as in Example 1. The resulting film exhibited the same excellent peelability as in Example 1. A film having a concavo-convex pattern on the surface was prepared in the same manner as above, except that the embossing quartz roll not coated with the photocatalyst layer was used. After the film was peeled from the embossing quartz roll, a slight amount of UV cured resin was observed on the embossing quartz roll surface.

### Example 3

A low refractive index layer was provided on the films having a concavo-convex pattern prepared in Examples 1 and 2 to prepare antiglaring antireflection films.

### Surface Treatment and Coating of Low Refractive Index Layer

### <Preparation of Antireflection Layer (Low Refractive Index Layer)>

Firstly, composite particles were prepared.

### Preparation of Composite Particles P-1

A mixture of 100 g of silica sol having an average particle size of 5 nm with a SiO₂ concentration of 20% by weight and 1900 g of pure water was heated to 80° C. This reaction mother liquid had a pH value of 10.5. 9000 g of a 1.5% by weight (in terms of SiO₂) sodium silicate aqueous solution and 9000 g of a 0.5% by weight sodium aluminate (in terms of Al₂O₃) aqueous solution were added simultaneously to the mother liquid. In the meantime, the temperature of the reaction solution was held at 80° C. The pH value of the reaction solution raised to 12.5 immediately after addition, but thereafter hardly changed. After termination of the addition, the reaction solution was cooled to room temperature, and washed by an ultrafiltration membrane to obtain a porous SiO₂.Al₂O₃ particle precursor dispersion (A) with a solid content of 20% by weight (Step 1).

One hundred grams of the above-obtained porous particle precursor dispersion (A) was added with 100 g of pure water, and heated at 95° C. Thereafter, 27000 g of a 1.5% by weight (in terms of SiO₂) sodium silicate aqueous solution and 27000 g of a 0.5% by weight sodium aluminate (in terms of Al₂O₃) aqueous solution were simultaneously but gradually added thereto at that temperature to grow particles, where the particles in the porous particle precursor dispersion (A) were employed as seed particles. After termination of the addition, the resulting solution was cooled to room temperature, washed by an ultrafiltration membrane and concentrated to obtain a porous SiO₂.Al₂O₃ particle precursor dispersion (B) with a solid content of 20% by weight (Step 1).

An aqueous hydrochloric acid with a pH of 3 of 10 liter and 5 liter of pure water were added to 500 g of the above-obtained porous particle precursor dispersion (B), washed with an ultrafiltration membrane to remove the dissolved aluminum salt and concentrated to obtain a porous SiO₂.Al₂O₃ particle dispersion (C) in which a part of aluminum was removed (Step 2).

A mixture of 1500 g of the porous particle dispersion (C), 500 g of pure water, 1750 g of ethanol, and 626 g of a 28% ammonia water was heated to 35° C., and added with 104 g of ethyl silicate (SiO₂ 28% by weight) to cover the porous particle surface with the hydrolyzed and polycondensated product of the ethyl silicate. The resulting solution was concentrated employing an evaporator to obtain a solid concentration of 5% by weight. The concentrated solution was added with a 15% by weight ammonia water to give a pH of 10, and subjected to heat treatment at 180° C. for 2 hours in an autoclave. The solvent of the resulting solution was replaced with ethanol employing an ultrafiltration membrane to obtain a dispersion of composite particles (P-1) having a solid content of 20% by weight (Step 3).

The average particle size, SiO₂/MOx (molar ratio) and refractive index of the composite particles (P-1) are shown in Table 1.

The average particle size was measured according to a dynamic light scattering method. The refractive index was measured employing Series A, AA produced by CARGILL Co., Ltd. as a standard solution as follows:

### <Measurement of Refractive Index of Particles>

(1) The solvent of the particle dispersion was evaporated through an evaporator to obtain residues.

(2) The residues were dried at 120° C. to obtain powder.

(3) Two or three droplets of a standard refractive index solution having a prescribed refractive index were dropped on a glass plate and mixed with the above-obtained powder to obtain a mixture droplet.

(4) The process (3) above was carried out employing various standard refractive index solutions and the refractive index of the standard refractive index solution providing a transparent mixture droplet was determined as being a refractive index of particles.

TABLE 1

| | | Particle | Porous particles | | Silica |
|---|---|---|---|---|---|
| | | precursor | | Average | covering |
| | | MOₓ/SiO₂ | MOₓ/SiO₂ | particle | layer |
| | Composition | (molar | (molar | diameter | Thickness |
| No. | of oxide | ratio) | ratio) | (nm) | (nm) |
| P-1 | Al/Si | 0.195 | 0.0105 | 48 | 6 |

| | Composite particles | | |
|---|---|---|---|
| | MOₓ/SiO₂ | | |
| | (molar | Average particle diameter | Refractive |
| No. | ratio) | (nm) | index |
| P-1 | 0.00695 | 60 | 1.38 |

### Surface Treatment

The following low refractive index layer coating solution was coated on the films having a concavo-convex pattern prepared in Examples 1 and 2, employing a micro-gravure coating method, and dried at 120° C. for one minute to give a low refractive index layer with a thickness of 0.1 μm. The resulting low refractive index layer was exposed to a 0.2 J/cm² ultraviolet ray under nitrogen atmosphere to form a low refractive index layer with a refractive index of 1.41.

### Preparation of Low Refractive Index Layer Coating Solution

Composite particles (P-1) with an average particle size of 60 nm and a refractive index of 1.38 was added to a mixed matrix of 95 mol % of Si(OC₂H₅)₄ and 5 mol % of CF₃(CF₂)₇(CH₂)₂Si(OCH₃)₃ so that the amount of the composite particles (P-1) was 50% by weight. The resulting solution was added with a 1.0 mol HCl solution and further diluted with aqueous solvent to obtain a low refractive index layer coating solution.

A film obtained by providing an antireflection layer on the concavo-convex pattern film (anti-glaring film) prepared employing an embossing roll provided with a photocatalyst layer did not produce streak unevenness during continuous manufacture thereof and showed stable coatability. While a film obtained by providing an antireflection layer on the concavo-convex pattern film (anti-glaring film) prepared employing an embossing roll without a photocatalyst layer provided sometimes produced streak unevenness during continuous manufacture thereof, resulting in lowering of coatability. The process of the invention of preparing a concavo-convex pattern film can provide a concavo-convex pattern film which excels in coatability of a layer such as an antireflection layer.

1. A process of producing a concavo-convex pattern film by forming a concavo-convex pattern on the surface of a transparent resin film employing an embossing roll having on the surface a convex-concavo pattern, wherein the embossing roll is made of glass and a photocatalyst layer containing a photocatalyst is provided on the surface of the embossing roll, the process comprising the steps of:
introducing a UV curable resin composition between the embossing roll and a transparent resin film provided around the embossing roll to form a UV curable resin layer;
exposing the UV curable resin layer to UV rays so as to form a UV cured resin layer having on the surface a concavo-convex pattern, the UV rays being emitted from the interior of the embossing roll; and
peeling the UV cured resin layer together with the transparent resin film from the embossing roll.

2. The process of producing a concavo-convex pattern film of claim 1, wherein the glass is quartz glass.

3. The process of producing a concavo-convex pattern film of claim 1, wherein the photocatalyst is at least one selected from titanium oxide, lead sulfide, zinc sulfide, tungsten oxide, iron oxide, zirconium oxide, cadmium selenide and strontium titanate.

4. The process of producing a concavo-convex pattern film of claim 3, wherein the photocatalyst is titanium oxide.

5. The process of producing a concavo-convex pattern film of claim 1, wherein the thickness of the photocatalyst layer is from 0.01 to 10 μm.

6. The process of producing a concavo-convex pattern film of claim 5, wherein the thickness of the photocatalyst layer is from 0.01 to 1 μm.

7. The process of producing a concavo-convex pattern film of claim 1, wherein the transparent resin film contains a UV absorbent.

8. The process of producing a concavo-convex pattern film of claim 1, wherein the transparent resin film is cellulose ester film.

9. The process of producing a concavo-convex pattern film of claim 1, wherein the surface of the embossing roll has an arithmetic average surface roughness Ra of from 0.02 to 2 μm.

10. The process of producing a concavo-convex pattern film of claim 1, wherein the concavo-convex pattern of the embossing roll is formed by sand blasting treatment.

11. The process of producing a concavo-convex pattern film of claim 1, wherein the concavo-convex pattern of the embossing roll is formed by hydrogen fluoride treatment.

12. The process of producing a concavo-convex pattern film of claim 1, wherein the peeling is carried out employing a peeling roll.

13. The process of producing a concavo-convex pattern film of claim 1, wherein the concavo-convex pattern film is an antiglaring film.
